(19) United States
(12) Patent Application Publication
(10) Pub. No.: US 2005/0105993 A1
(43) Pub. Date: May 19, 2005

(54) Rear eject body for haulage units

(76) Inventor: LeRoy Hagenbuch, Peoria, IL (US)

Correspondence Address: HALLIHAN INTELLECTUAL PROPERTY LAW, LTD;Suite 2080, 125 South Wacker Drive, Chicago, IL, 60606, US

(21) Appl. No.: 10/894,651

(22) Filed: Jul. 19, 2004

Related U.S. Application Data
(63) Continuation-in-part of application No. 10/374,803, filed on Feb. 25, 2003.
(60) Provisional application No. 60/488,457, filed on Jul. 17, 2003.

(51) Int. Cl. B60P 1/00

(52) U.S. Cl. 414/511

(57) ABSTRACT

A hydraulic cylinder for a rear eject body for a truck is provided. The body includes a floor and a pair of opposing sidewalls. A tailgate extends between the opposing sidewalls at a rear end of the rear eject body. The tailgate is pivotally supported for movement between an open position and a closed position. An ejector is supported in the rear eject body for movement between a retracted position at a forward end of the body and an extended position at the rear end of the body. The hydraulic cylinder includes a regenerating hydraulic circuit that causes oil coming out of the retract side of the hydraulic circuit to be directed into the extend side of they hydraulic cylinder, which enables the hydraulic cylinder to extend more quickly than would otherwise be possible.

### CROSS-REFERENCE TO RELATED APPLICATIONS

This application claims the benefit of U.S. Provisional Patent Application No. 60/488,457, filed Jul. 17, 2003, which is incorporated herein by reference. This application is also a continuation-in-part of U.S. application Ser. No. 10/374,803, filed Feb. 25, 2003, which is incorporated herein by reference.

### BACKGROUND

Off-highway trucks equipped with rear eject bodies are used to haul and dump materials in haulage applications such as mines, construction sites and landfills. Rear eject bodies have a number of advantages over conventional rear dump bodies. For example, rear eject bodies typically are self-cleaning thereby minimizing carry back of sticky materials. Additionally, this style of body allows dumping on the go, increasing truck productivity. Dumping on the go also minimizes the need for additional support equipment to spread and level the dumped material. With regard to the dumping of materials, rear eject bodies allow materials to be dumped on steeper slopes and in areas where there is soft truck underfoot conditions. Moreover, trucks with rear eject bodies can dump their loads in areas with overhead wires and bridges as well as in tunneling applications.

Rear eject bodies use an ejector blade that is moved horizontally from the front end to the rear end of the truck body by one or more hydraulic cylinders to eject and dump material from the truck body. Since the body does not have to be raised for dumping, rear eject bodies are particularly suited for haulage applications in which there is limited overhead dump clearance (e.g., because of wires, bridges, tunnels, and trees). Additionally, rear eject bodies dump materials in a more controlled manner. For example, a rear eject body can dump material while the truck is still moving in order to spread the dumped material over a larger area.

In general, rear eject bodies are well known on both off-highway trucks and street legal refuse trucks. Unfortunately, many commercially available rear eject bodies have a number of drawbacks. For example, since typical rear eject bodies have a number of moving parts requiring regular lubrication and maintenance, they can be costly and time-consuming to maintain. Moreover, because large hydraulic cylinders are required to move the ejector blade, rear eject bodies can be quite expensive. Some rear eject bodies also use additional hydraulic cylinders to operate the tailgate, further increasing the cost. Many rear eject bodies also dump material relatively slowly, increasing dump cycle times and lowering productivity.

However, the large hydraulic cylinders that are used in some applications can be very long and take up a lot of space. A multi-stage, double acting telescopic hydraulic cylinder could be used in place of larger hydraulic cylinders for on rear-eject bodies, or in other applications that would benefit from using hydraulic cylinders of a more compact size.

However, a multi-stage, double acting telescopic hydraulic cylinder can be prone to misfiring as disclosed in LeRoy Hagenbuch's U.S. published patent application 20030223849, published on Dec. 4, 2003 (filed on Feb. 25, 2003) and WIPO publication WO03072392 A3, both of which are incorporated herein by reference. Misfiring is a particular problem in applications where the cylinder is operated in a position where it tends to be in a more horizontal position than in a more vertical position (±<45° from the horizontal position). This problem is exacerbated when the cylinder is operated in a position where approaches the horizontal position, such as within ±20°, 15°, 10°, 5°, 3° or 0° from the horizontal position.

In one form, the present invention includes a rear eject body for a truck. The body includes a floor and a pair of opposing sidewalls. A tailgate extends between the opposing sidewalls at a rear end of the rear eject body and is pivotally supported for movement between an open position and a closed position. An ejector blade is supported in the rear eject body for movement between a retracted position at a forward end of the body and an extended position at the rear end of the body. A horizontal multi-stage, double acting telescopic hydraulic cylinder is coupled to the truck body and is used to move the ejector blade between a retracted position and an extended position.

The multi-stage, double acting telescopic hydraulic cylinder can include a regenerating feature that can provide a higher hydraulic inflow (than can be achieved using a hydraulic pump alone) during extension of the ejector blade by causing the hydraulic fluid that exits the retract side (of the hydraulic cylinder) to flow back into the extend line. This allows the hydraulic cylinder to be extended in a quicker amount of time for the same size hydraulic pump and can, in some circumstances, allow the hydraulic dump circuit to be used as the hydraulic pump used to control the ejector blade to eject the load in a timely manner.

### BRIEF DESCRIPTION OF THE DRAWINGS

FIG. 1 is a side view of an articulated off-highway truck having an exemplary rear eject body constructed in accordance with the present invention showing the ejector blade retracted and the tailgate closed.

FIG. 2 is a rear view of the truck and rear eject body of FIG. 1 showing the ejector blade retracted and the tailgate closed.

FIG. 3 is a side view of the truck and rear eject body of FIG. 1 showing the ejector blade extended and the tailgate open.

FIG. 4 is a rear view of the truck and rear eject body of FIG. 2 showing the ejector blade extended and the tailgate open.

FIG. 5 is a perspective view of the rear eject body of FIG. 1 showing the ejector blade retracted and the tailgate closed.

FIG. 6 is a perspective view of the rear eject body of FIG. 1 showing the ejector blade extended and the tailgate open.

FIG. 7 is a front view of the rear eject body of FIG. 1.

FIG. 8 is a front perspective view of the rear eject body of FIG. 1 showing the ejector blade extended and the tailgate open.

FIG. 9 is an enlarged partial end view of the rear eject body of FIG. 1 showing one of the ejector guide tracks/slides.

FIG. 10 is an enlarged partial end view of the rear eject body of FIG. 1 showing one of the ejector guide tracks and one of the ejector blade sleds with the ejector blade cutaway.

FIG. 11 is an enlarged end view of an alternative guide track/slide and sled arrangement for the rear eject body of the present invention.

FIG. 12 is an enlarged partial side perspective view of the rear eject body of FIG. 1 showing the inclined section of one of the guide tracks at the forward end of the rear eject body which helps retain the ejector blade in the retracted position.

FIG. 13 is an enlarged partial side perspective view of a rear eject body according to the present invention having an alternative guide track with a flat section of guide track in front of the inclined section at the forward end of one of the guide tracks which helps retain the ejector blade in the retracted position.

FIG. 14 is a partial perspective view of the rear eject body of FIG. 1 with a portion of one of the body sidewalls cutaway so as to show the tailgate actuation system.

FIG. 15 is an enlarged perspective view of the ejector blade and tailgate actuation system of the rear eject body of FIG. 1 showing the ejector blade in the fully retracted position.

FIG. 16 is a perspective view of the ejector blade and tailgate actuation system of the rear eject body of FIG. 1 showing the ejector blade in the fully retracted position and the tailgate closed.

FIG. 17 is a perspective view of the ejector blade and tailgate actuation system of the rear eject body of FIG. 1 showing the ejector blade after it has started moving rearward towards the extended or eject position and the tailgate in the open position.

FIGS. 18-28 are enlarged partial top plan views of the ejector blade and tailgate actuation system of the rear eject body of FIG. 1 showing the sequence of operation of the tailgate actuation system as the ejector blade moves from the fully retracted position to the extended position and back to the fully retracted position. The direction of travel of the ejector blade is indicated by the respective arrows; in FIGS. 18-24, the ejector blade is extending or moving to the rear of the rear eject body; while in FIGS. 25-28, the ejector blade is retracting or moving to the front of the rear eject body.

FIG. 29 is an enlarged partial side view of the rear eject body of FIG. 1 showing the tailgate in the nearly vertical or closed position.

FIG. 30 is an enlarged partial side view of the rear eject body of FIG. 1 showing the tailgate in a horizontal position between the closed and open positions.

FIG. 31 is an enlarged partial side view of the rear eject body of FIG. 1 showing the tailgate in the nearly open position.

FIGS. 32a-c are partial side views of the tailgate actuation system and tailgate of the rear eject body of FIG. 1 showing the chain and chain drum as the tailgate moves between the closed and open positions.

FIG. 33 is an enlarged partial side view of a rear eject body according to the present invention which has an alternative chain drum configuration showing the tailgate in the closed position.

FIG. 34 is an enlarged partial side view of the rear eject body of FIG. 33 showing the tailgate in the nearly open position.

FIG. 35 is an enlarged front perspective view of the rear eject body of FIG. 1 showing the hydraulic cylinder mounting arrangement.

FIG. 36 is an enlarged front perspective view of the rear eject body of FIG. 1 showing the hydraulic cylinder mounting arrangement.

FIG. 37 is an enlarged partial side view of a rear eject body according to the present invention which has an alternative tailgate pivot arrangement showing the tailgate in the closed position.

FIG. 38 is an enlarged partial side view of the rear eject body of FIG. 37 showing the tailgate in the open position.

FIG. 39 is an enlarged partial perspective view showing the forward end of one of the body sidewalls and the various mounting positions for the quick release dog of the tailgate actuation system.

FIG. 40 is a schematic drawing of a hydraulic control system for the hydraulic cylinder of the rear eject body of FIG. 1 with the hydraulic cylinder being extended. The arrows indicate direction of hydraulic fluid flow into and out of hydraulic control system.

FIG. 41 is a schematic drawing of the hydraulic control system of FIG. 40 with the hydraulic cylinder being retracted. The arrows indicate direction of hydraulic fluid flow into and out of the hydraulic control system.

FIG. 42 is a schematic drawing of an alternative hydraulic control system for the hydraulic cylinder that also controls tailgate cylinders which could be used to move the tailgate between the open and closed positions with the hydraulic cylinder and the ejector being extended.

FIG. 43 is a schematic drawing of the control system of FIG. 42 with the hydraulic cylinder and the ejector being retracted.

FIG. 44 is a schematic drawing of an alternative hydraulic control system for the hydraulic cylinder of the rear eject body of FIG. 1 with the hydraulic cylinder being extended and utilizing a regenerative hydraulic circuit using a pilot pressure to close valve. The arrows indicate direction of hydraulic fluid flow into and out of hydraulic control system.

FIG. 45 is a schematic drawing of the hydraulic control system of FIG. 44 with a pressure relief valve activated. The arrows indicate direction of hydraulic fluid flow into and out of hydraulic control system.

FIG. 46 is a schematic drawing of the hydraulic control system of FIG. 44 with the hydraulic cylinder being retracted. The arrows indicate direction of hydraulic fluid flow into and out of hydraulic control system.

FIG. 47 is a schematic drawing of the hydraulic control system of FIG. 46 with a pressure relief valve activated. The arrows indicate direction of hydraulic fluid flow into and out of hydraulic control system.

FIG. 48 is a schematic drawing of an alternative hydraulic control system for the hydraulic cylinder of the rear eject body of FIG. 1 with the hydraulic cylinder being extended and utilizing a regenerative hydraulic circuit using a pilot pressure to open valve. The arrows indicate direction of hydraulic fluid flow into and out of hydraulic control system.

FIG. 49 is a schematic drawing of the hydraulic control system of FIG. 48 with a pressure relief valve activated. The arrows indicate direction of hydraulic fluid flow into and out of hydraulic control system.

FIG. 50 is a schematic drawing of the hydraulic control system of FIG. 47 with the hydraulic cylinder being retracted. The arrows indicate direction of hydraulic fluid flow into and out of hydraulic control system.

FIG. 51 is a schematic drawing of the hydraulic control system of FIG. 50 with a pressure relief valve activated. The arrows indicate direction of hydraulic fluid flow into and out of hydraulic control system.

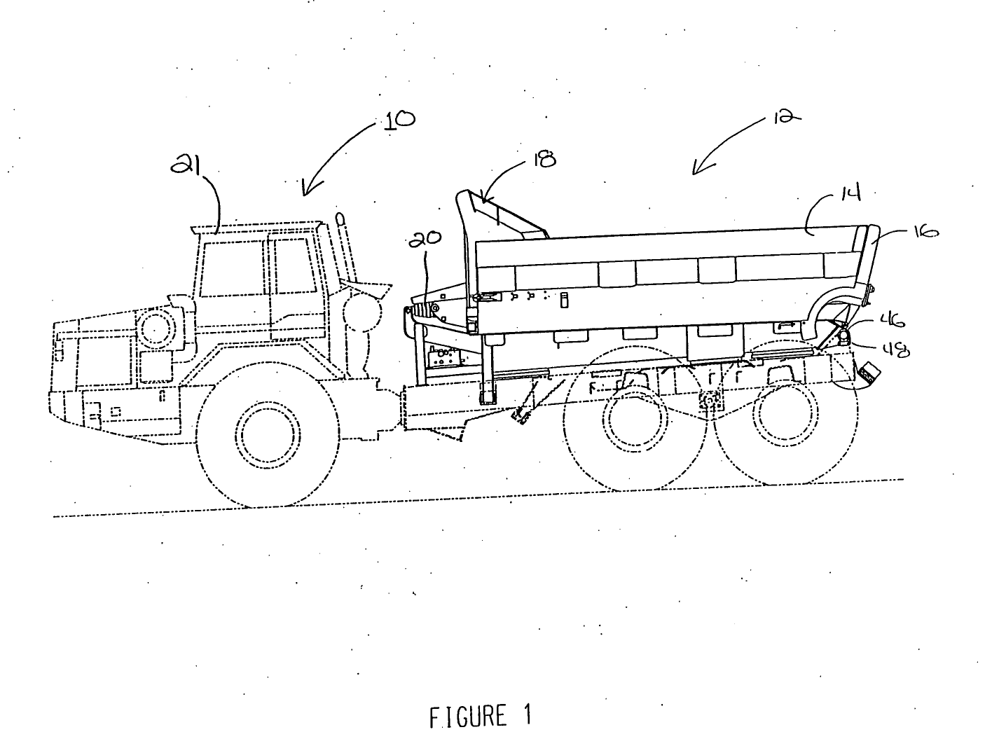

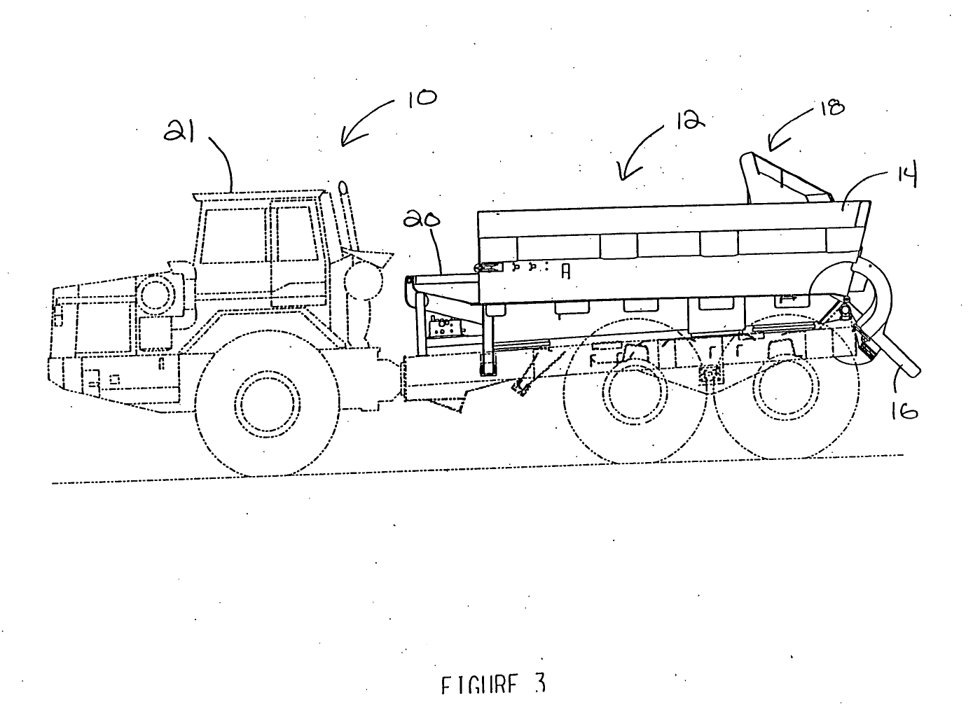

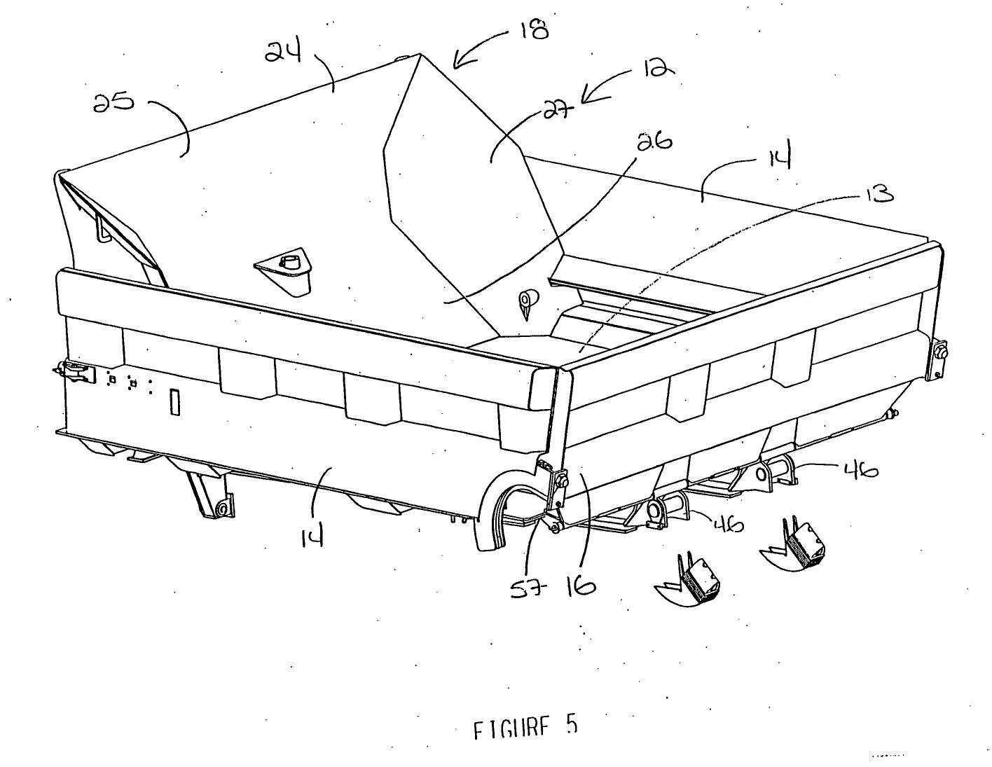

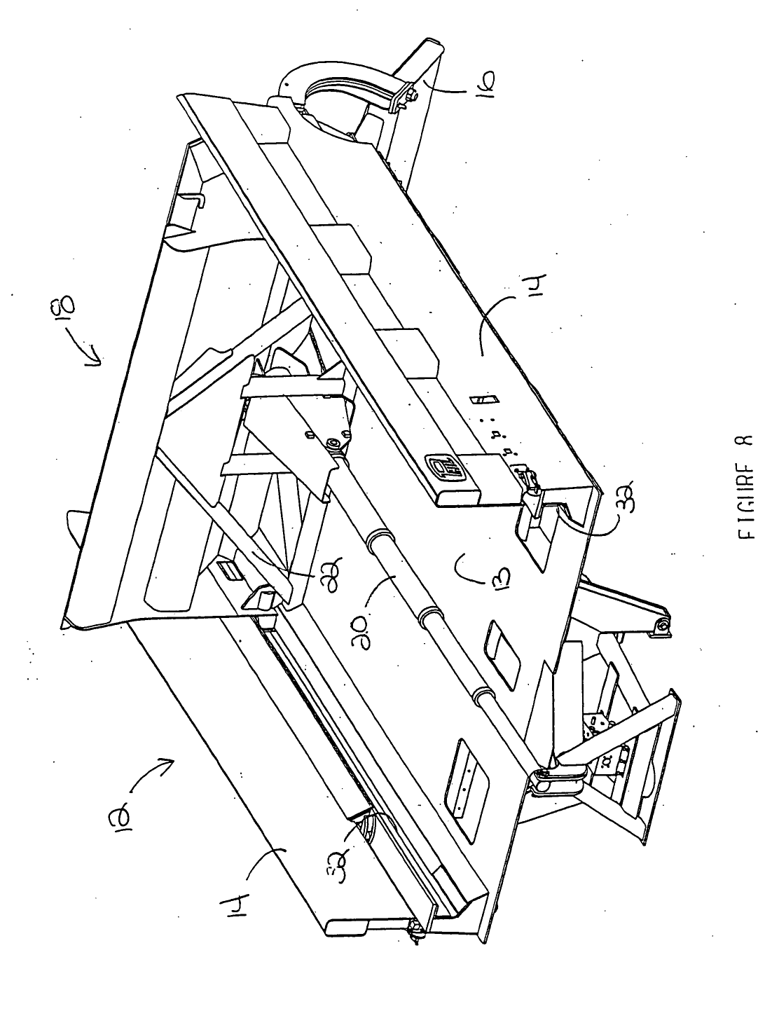

Referring now more particularly to the drawings, there is shown in FIGS. 1-4 an illustrative off-highway truck 10 having a rear eject body 12 constructed in accordance with the teachings of the present invention. The illustrated rear eject body 12 consists of a floor 13, two sidewalls 14, tailgate 16, and an ejector blade 18. The ejector blade 18 when actuated pushes a load in the rear eject body 12 from the front of the rear eject body out the rear of the rear eject body. In particular, the ejector blade 18 is moved from a body loaded or fully retracted position at the front of the rear eject body 12 (see, e.g., FIGS. 1, 2, 5 and 7) to a body empty or fully extended position at the rear of the rear eject body 12 (see FIGS. 3, 4, 6 and 8) by, in this case, a multi-stage double-acting hydraulic cylinder 20. As used herein, the terms “front” and “forward” and “rear” and “rearward” are used with respect to the truck cab 21 being at the front end of the truck 10 and the tailgate 16 being at the rear end of the truck 10 (see FIGS. 1 and 3).

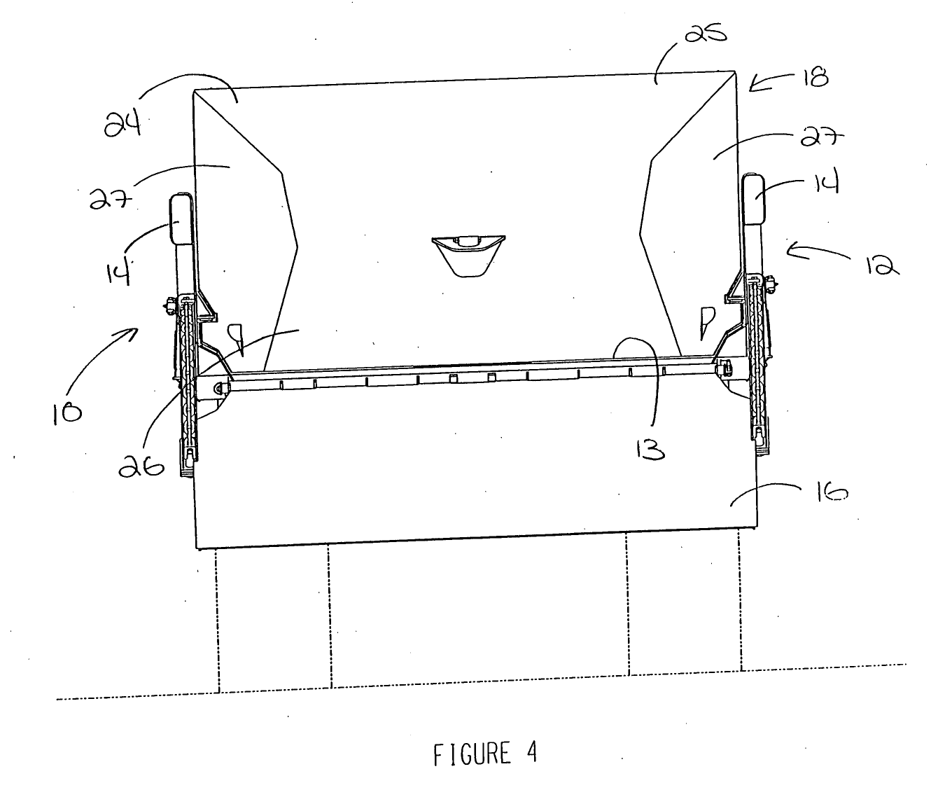

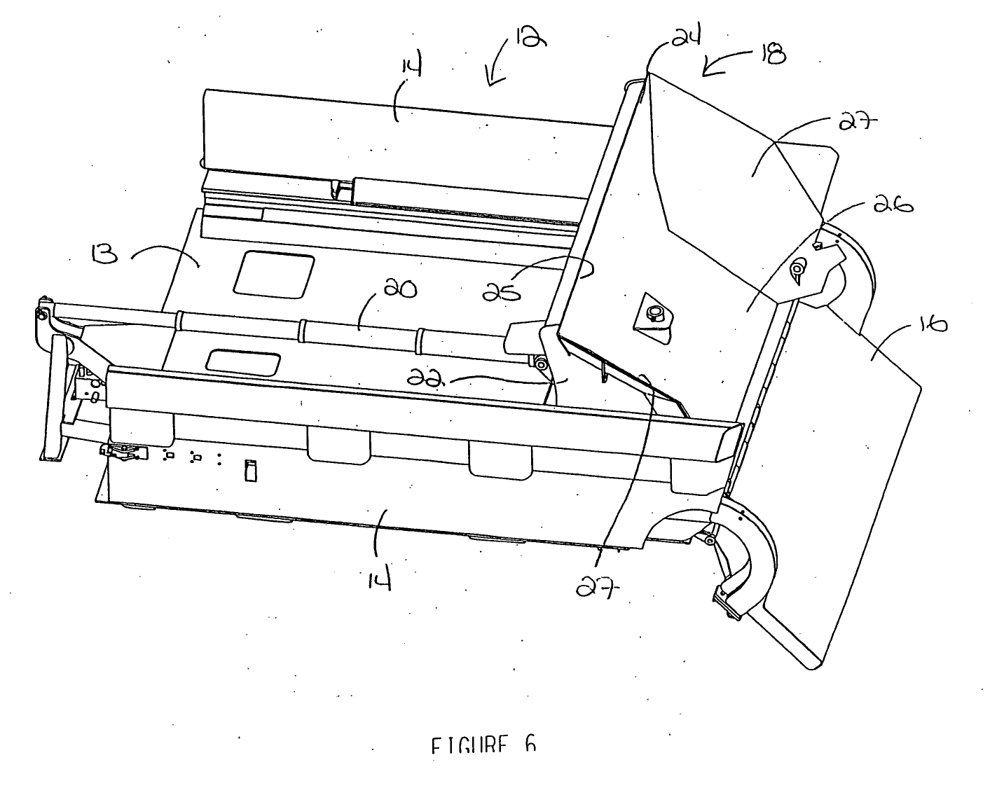

In the illustrated embodiment, the ejector blade 18 generally includes a frame 22 (see FIGS. 6-8) that supports an ejector plate 24. As shown in FIGS. 4-6, the ejector plate 24 is oriented so as to face towards the rear end of the rear eject body 12 and extends between the sidewalls 14 of the rear eject body 12 and upwards from the floor 13 of the rear eject body 12 to a distance above the upper edges of the sidewalls 14. The illustrated ejector plate 24 includes an upper face 25, a lower face 26 and a pair of opposing side faces 27. To pull material away from the sidewalls 14 and direct it towards the center of the rear eject body 12, each of the side faces 27 of the ejector plate 24 angles inward towards the center of the body 12 as it extends forward toward the front end of the rear eject body 12. The lower face 26 of the ejector plate 24 angles upward away from the body floor 13 as it extends forward toward the front end of the rear eject body 12 to help lift material up and somewhat off the body floor 13. The upper face 25 of the ejector blade 24, in turn, angles downward towards the body floor 13 as it extends forward toward the front end of the rear eject body 12. This configuration helps prevent material from tumbling over the top of the ejector plate 24 when it is pushing material rearward.

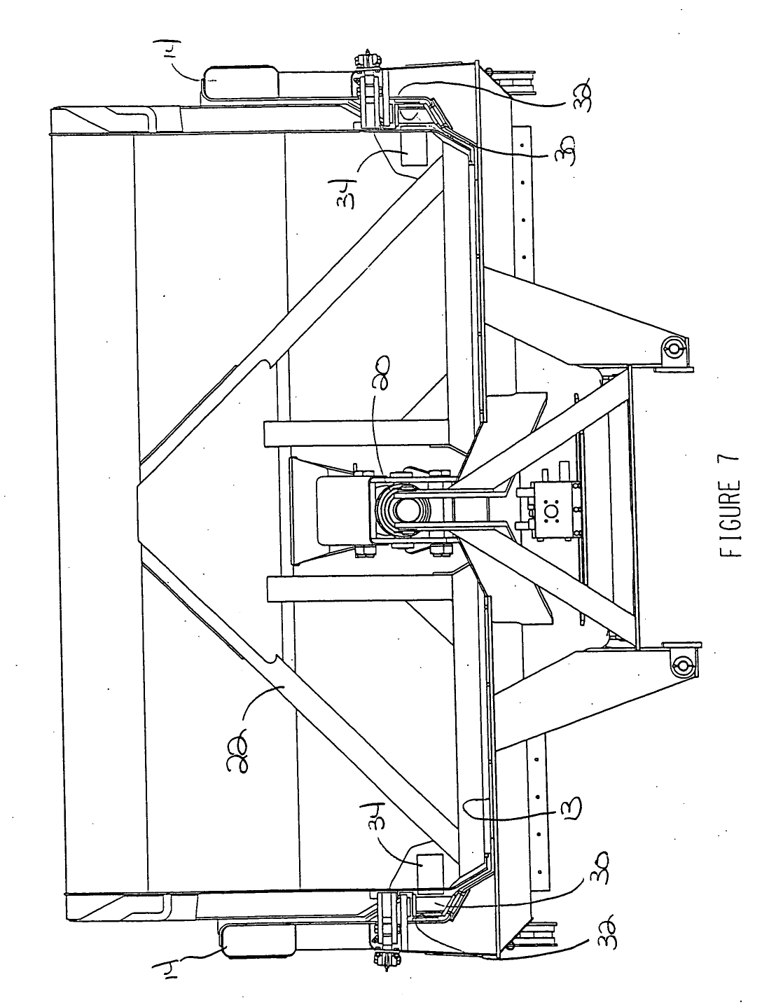

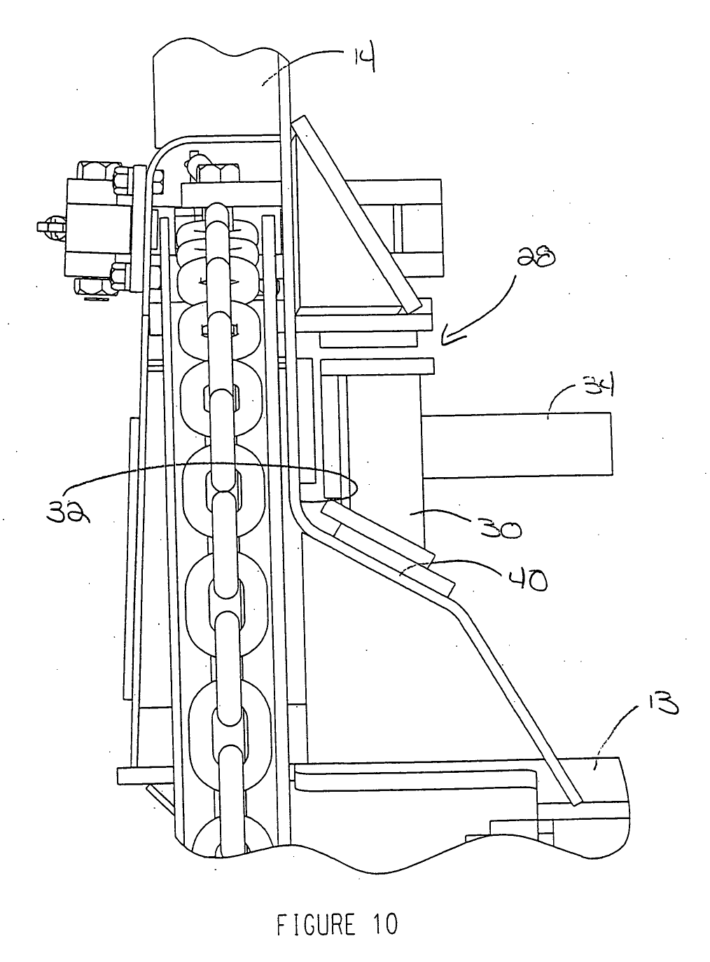

To guide the ejector blade 18 as it moves between the body loaded or fully retracted position at the front of the rear eject body 12 and the body empty or fully extended position at the rear of the rear eject body 12, the ejector blade 18 includes a guide assembly 28 (see FIG. 10). Typically, conventional ejector blades ride on rollers or cam followers as they move between the front and rear of the truck body. Unfortunately, these rollers and cam followers require regular maintenance and lubrication. In contrast, with one embodiment of the present invention, the guide assembly 28 for the ejector blade 18 can include sleds 30 (see, e.g., FIGS. 7, 10 and 15) that are received and slide in corresponding guide tracks 32 (see, e.g., FIGS. 7-10) arranged along the sidewalls 14 of the rear eject body 12. Unlike conventional rollers and cam followers, the sleds 30 and guide tracks 32 do not have any lubrication points, thereby substantially reducing the required maintenance for the ejector blade 18.

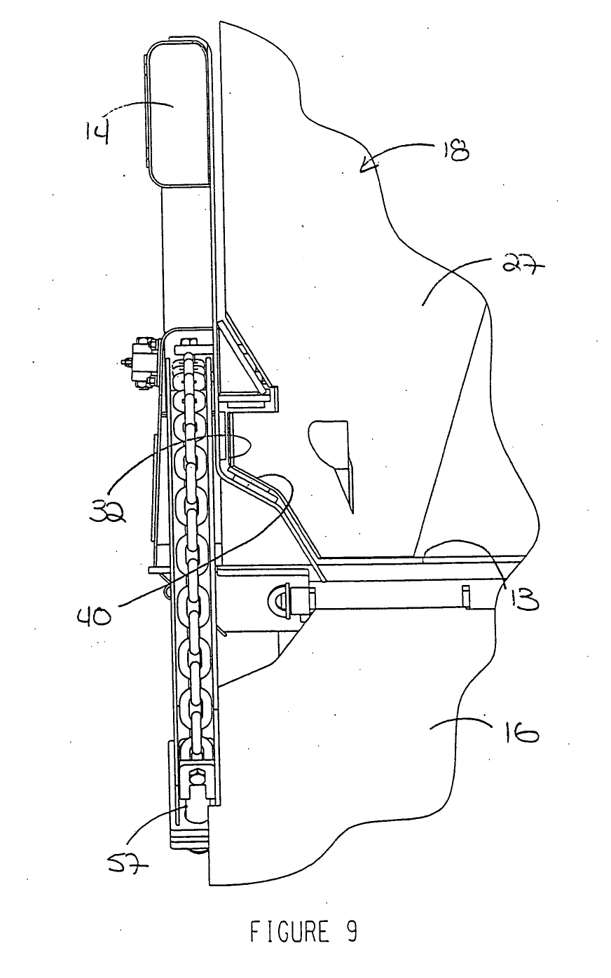

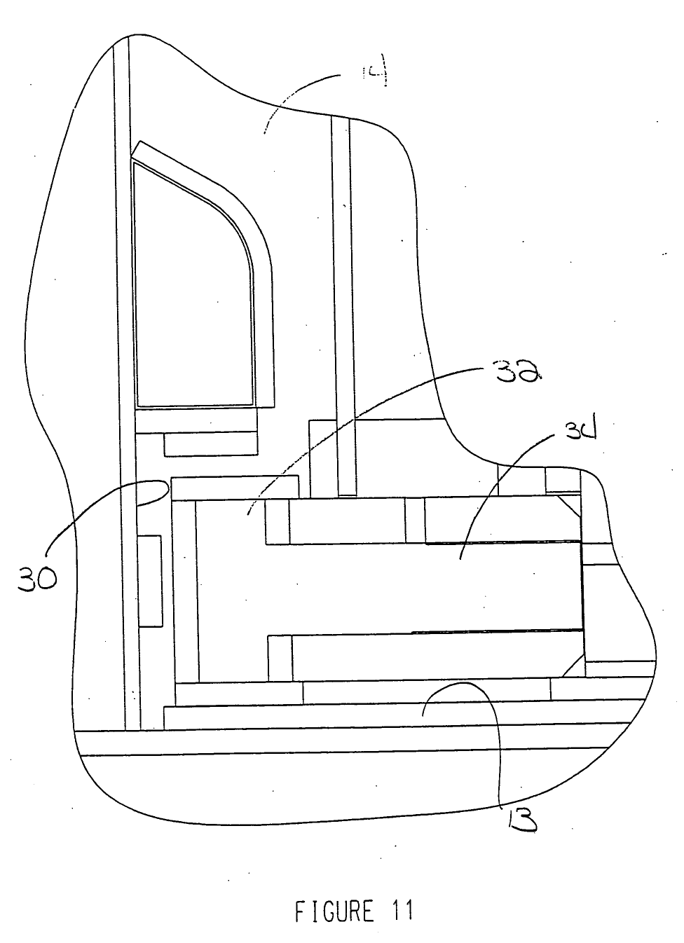

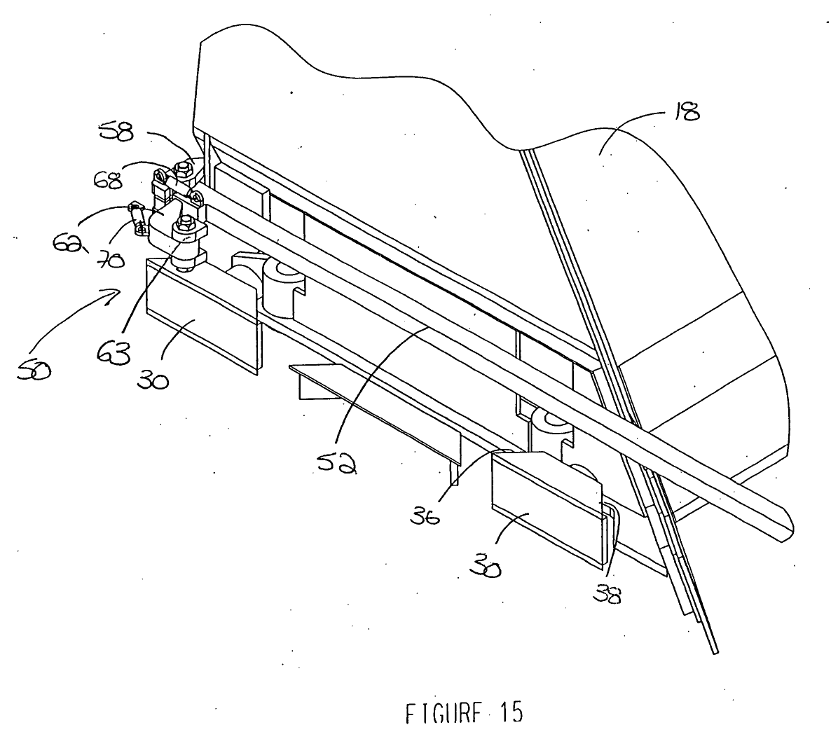

One guide track 32 is arranged along the inner side of each of the two sidewalls 14 of the rear eject body 12 (one of the tracks can be seen in FIGS. 9 and 10 and both can be seen in FIG. 7). In the illustrated embodiment, the ejector blade 18 has two sleds 30 on each side of the ejector blade frame 22 with one side being shown in FIG. 15. These sleds 30 are positioned near the four bottom corners of the ejector blade 18. Each sled 30 is supported on the end of a respective threaded rod 34 (FIGS. 10-11) that is received in a corresponding threaded tube on the ejector blade 18. The use of the threaded rods 34 allows the position of the sleds 30 to be adjusted relative to the ejector blade 18 thereby ensuring a good fit.

To facilitate sliding of the sleds 30 in the guide tracks 32, the sleds 30 can be made of or plated with a hardened steel material. Additionally, the guide tracks 32 in which the sleds 30 ride can also be lined or made out of a very hard steel material such as the same material used for the sleds 30. In particular, the three sides of the guide track 32 (i.e., outside, upper and lower walls of the track—see FIG. 10) can be either lined or made of a very hard steel material. Two examples of steel materials that are suitable for use in constructing the sleds 30 and guide tracks 32 are Hadfield manganese steel, which is a 11-14% manganese steel, and the fused alloy steel plate sold under the tradename Arcoplate by Alloy Steel International, Inc. of 42 Mercantile Way P.O. Box 3087 Malaga DC 6945, Western Australia. Arcoplate wear plate consists of a chromium carbide rich (±60%) steel alloy overlay on a mild steel backing. Additional information regarding the Arcoplate material can be found at www.arcoplate.com.au. One example of a suitable Hadfield manganese steel is the wear-resistant high manganese steel sold under the tradename Manganal by Stulz Sickles Steel Company of Elizabeth, N.J. Manganal is a high manganese austentitic, work hardening steel that typically is 12-14% manganese and 1.00-1.25% carbon. Additional information regarding the Manganal material can be found at www.stulzsicklessteel.com. The Hatfield manganese and Arcoplate materials are very hard such that each can operate against itself without galling.

To help ensure that the guide tracks 32 remain clear of debris, the sleds 30 and guide tracks 32 can be configured such that as the sleds 30 move between the front and rear of the rear eject body 12, debris is cleaned out of the tracks. Specifically, in the illustrated embodiment as shown in FIG. 15, each of the sleds 30 has a tapered configuration at both its front and end rear end that allows the sleds 30 to scrape debris away from the walls of the guide track 32 and direct the debris back towards the center of the rear ejectbody 12 as they move between the front and rear ends of the rear eject body 12. In this case, the forward end of each sled 30 includes upper and lower edges 36 (only the upper edge can be seen in FIG. 15) that angle inward and away from the body sidewalls 14 as the edges extend forward. Similarly, the rear end of each of the sleds 30 includes upper and lower edges 38 (only the upper edge can be seen in FIG. 15) that angle inward and away from the body sidewalls 14 as the edges extend rearward.

To further facilitate cleaning of the guide tracks 32, the guide tracks 32 can be configured so as to have a bottom wall 40 angling downward and inward toward the center of the rear eject body 12 as it extends away from the body sidewall 14 as shown, for example, in FIGS. 9 and 10. When the sleds 30 slide back and forth in the guide tracks 32, the debris that is dislodged by the sleds 30 falls onto the bottom wall 40 of the guide track 32. Because it is set at an angle, the debris that falls on to the bottom wall 40 of the track 32 slides or is otherwise directed out of the guide track 32 and towards the center of the rear eject body 12. In the embodiment illustrated in FIGS. 9 and 10, the guide tracks 32 are also elevated a distance above the body floor 13. The elevation of the guide tracks 32 creates space for any debris that is expelled from the guide tracks 32. Alternatively, the guide tracks 32 could be arranged so as to be level with the body floor 13 as shown in FIG. 11.

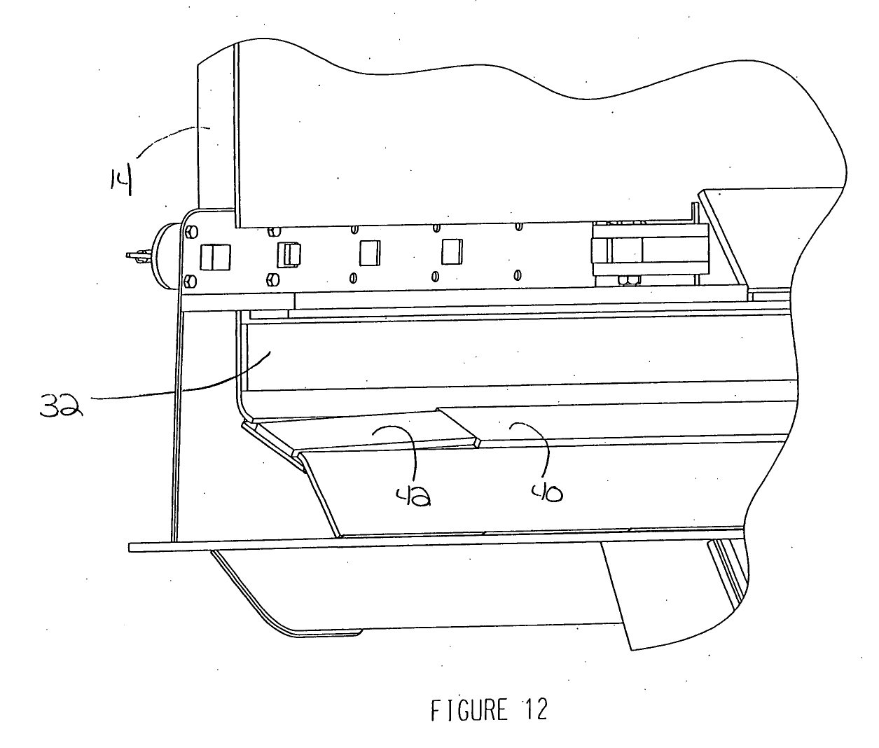

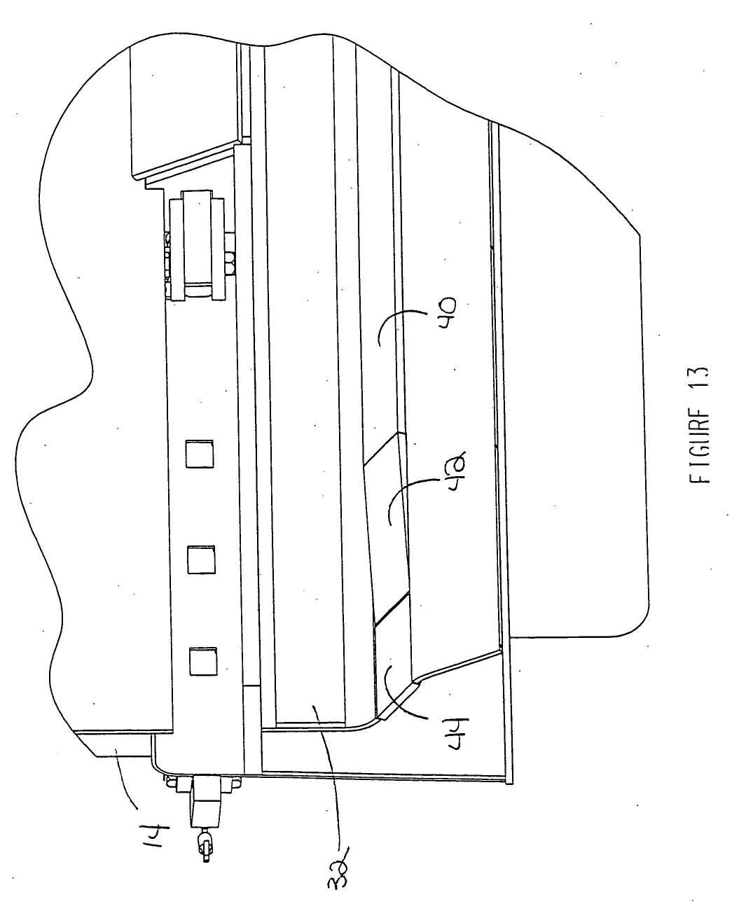

To help prevent the ejector blade 18 from drifting rearward when the rear eject body 12 is empty, such as when the truck 10 is driven from a dump point back to a loading point, each of the guide tracks 32 can be configured with an incline near its forward end that the corresponding sleds 30 have to travel up when the ejector blade 18 first starts moving rearward. In the embodiment illustrated in FIG. 12, a short inclined track section 42 is provided in the bottom wall 40 at the forward end of each guide track 32. Each inclined track section 42 angles downward as it extends toward the forward end of the guide track 32. This downward angle creates a recess in which the forward sled 30 on each side of the ejector blade 18 rests when the ejector blade 18 is in the fully retracted position. Since these forward ejector blade sleds 30 must travel up the inclined track sections 42 in order to move rearward, the ejector blade 18 is essentially held by gravity at the forward end of the rear eject body 12 when the hydraulic cylinder 20 is retracted. In an alternative embodiment, a, recessed flat track section 44 can be provided at the forward end of each guide track 32 as shown in FIG. 13. This recessed flat track section 44 is joined to the remainder of the guide track 32 by an inclined track section 42 that angles upward as it extends rearward in order to provide resistance to any rearward drift of the ejector blade 18. The recessed, flat track section 44 permits the sleds 30 to be oriented parallel to the ground when the ejector blade 18 is fully forward. The inclined track section 42 shown in FIG. 13 is at a slightly steeper angle than the inclined track section 42 of FIG. 12. As a result, the inclined track section 42 of FIG. 13 offers more resistance to any rearward drift of the ejector blade 18.

To reduce the friction associated with ejecting material from the rear eject body 12, the floor 13 of the rear eject body 12 can be lined with a material having a low coefficient of friction as compared to conventional steel plate. Using a material with a—relatively low coefficient of friction reduces the amount of force necessary to eject material from the rear eject body 12. As a result, a relatively smaller hydraulic cylinder 20 can be used to move the ejector blade 18 thereby reducing the cost of the rear eject body 12. The use of a low coefficient of friction material also results in a relatively faster movement of the ejector blade 18 between the retracted and extended positions. Two examples of suitable materials for lining the body floor 13 are Hadfield manganese steel and the wear plate sold under the Arcoplate tradename mentioned above. As noted above, both Hadfield manganese steel and Arcoplate wear plate are extremely hard, and when polished, have an extremely low coefficient of friction. Advantageously, these materials are also very resistant to abrasion and wear caused by material sliding across the body floor 13.

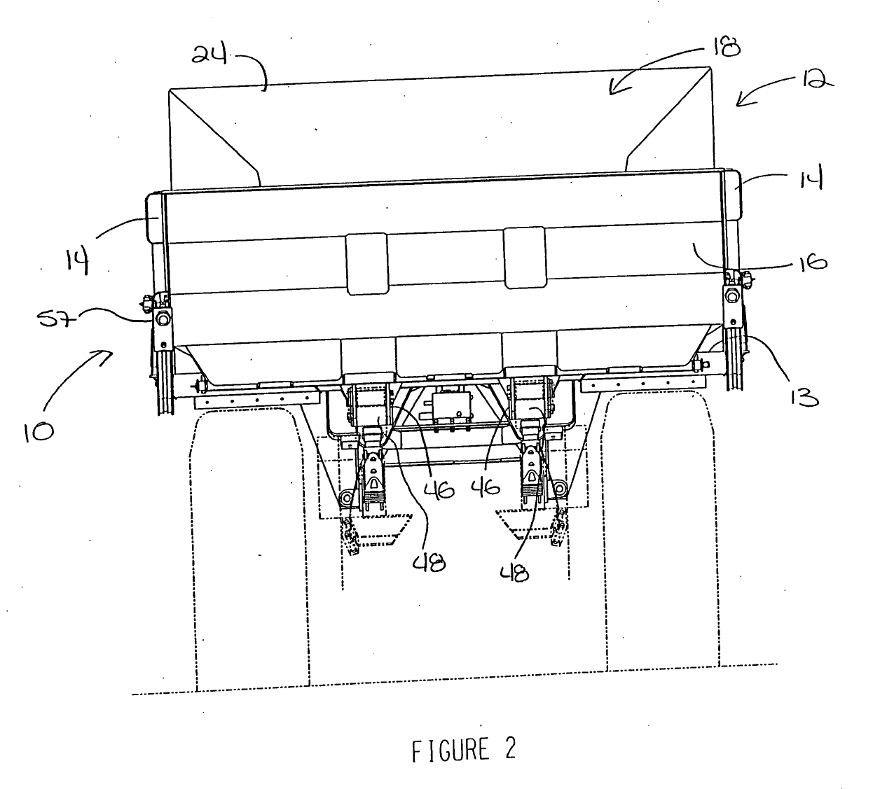

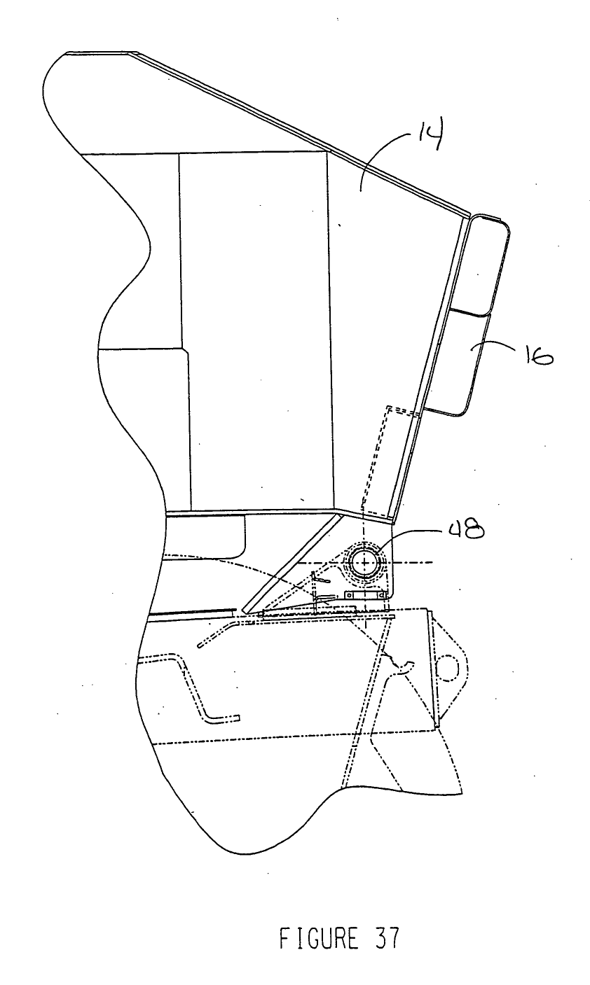

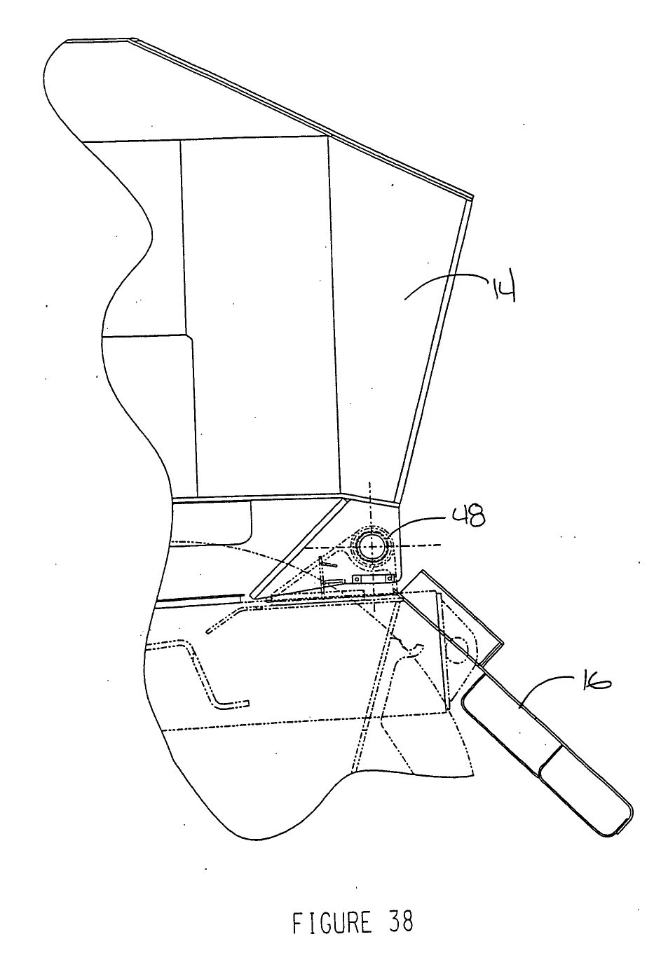

To allow the illustrated rear eject body 12 to be easily mounted to existing trucks that are configured to receive a pivotable dump body, the rear eject body 12 can be configured to be mountable to the standard truck chassis dump body pivot mounts. In particular, as best shown in FIGS. 1, 2 and 5, a pair of mounting brackets 46 are provided on the underside of the body floor 13 adjacent the rear end thereof. When installing the rear eject body 12, these mounting brackets 46 can be connected to the dump body pivot mounts 48 that are typically provided on a truck chassis configured to receive a pivotable dump body such as in the illustrated embodiment (see, e.g., FIGS. 1 and 2). Alternatively, the dump body pivot mounts 48 on the truck chassis could also be used as the pivot points for the tailgate 16 such as shown in FIGS. 37 and 38.

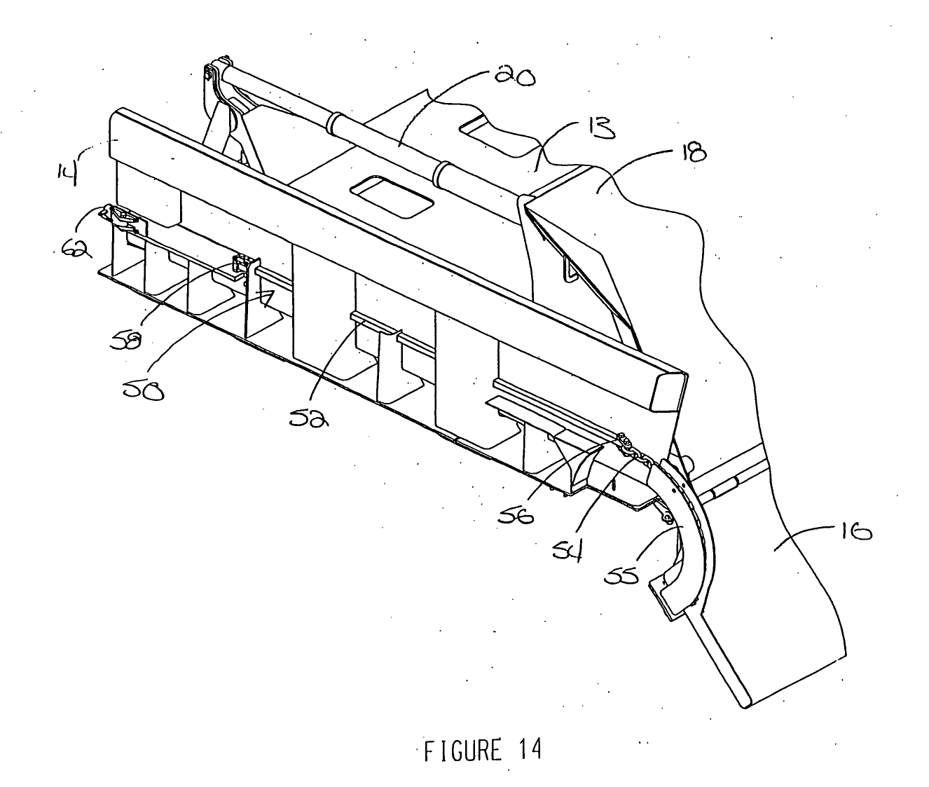

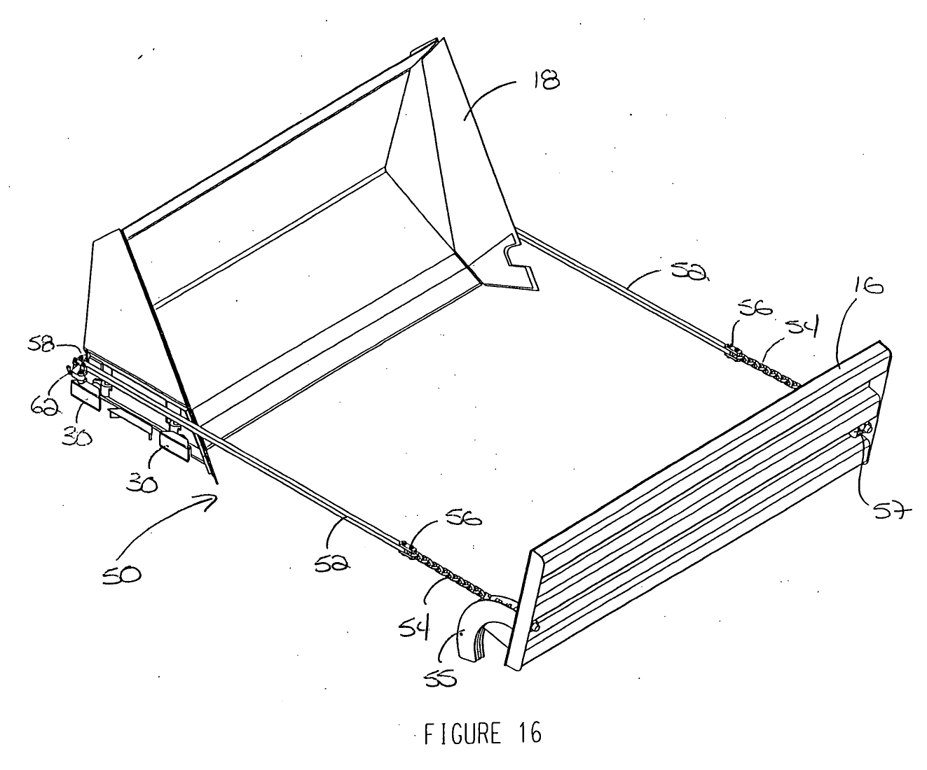

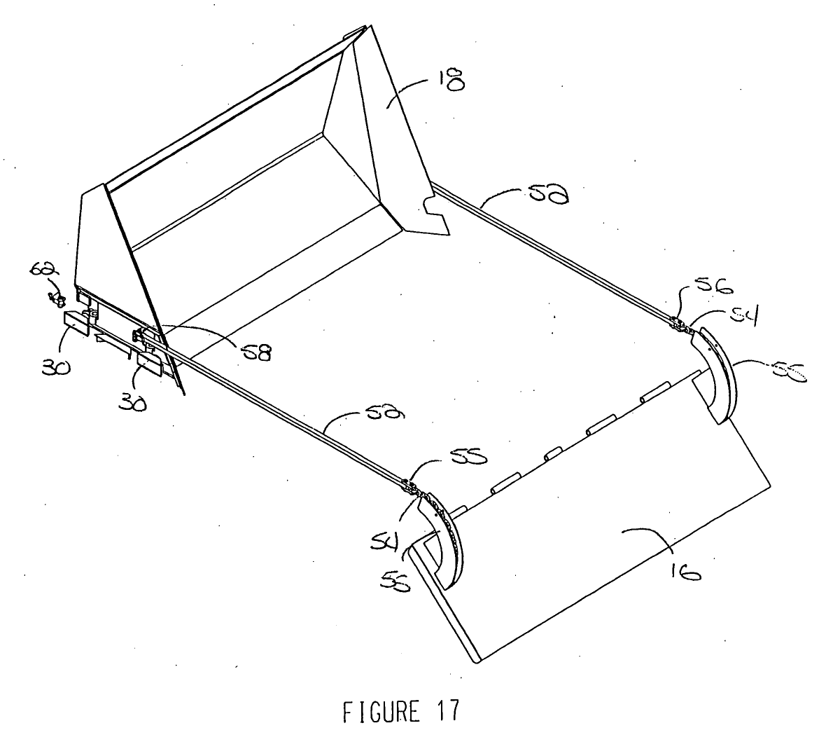

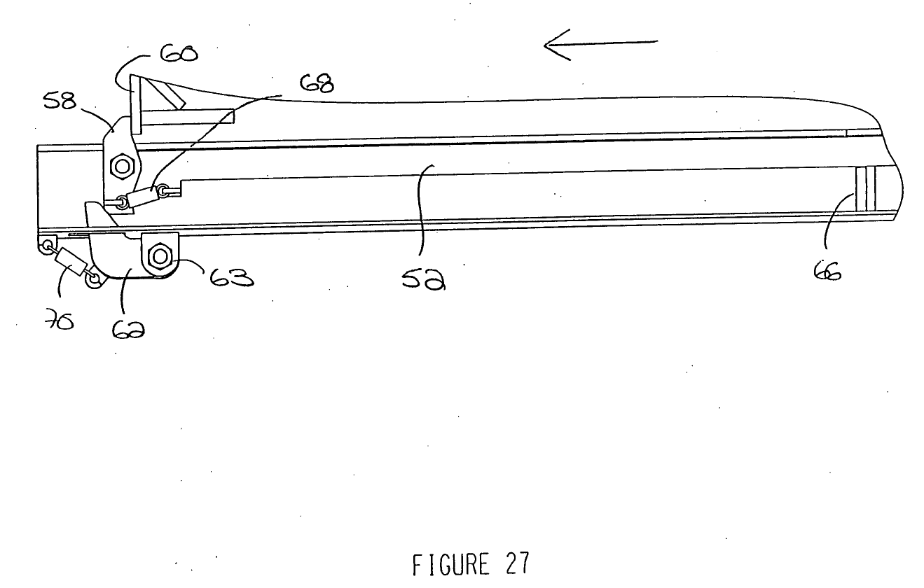

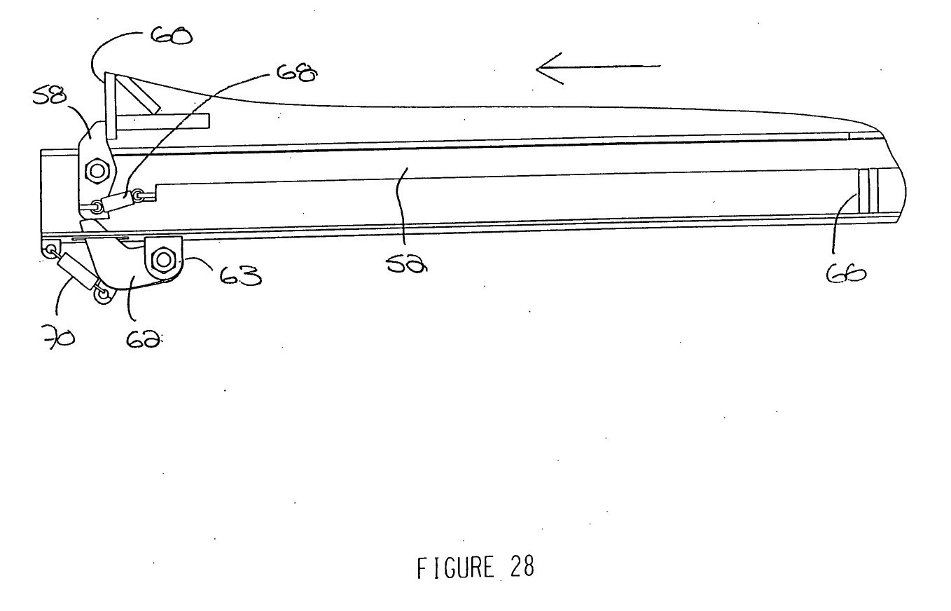

To control movement of the tailgate 16 between the open and closed positions so that the load can be ejected out of the body, the illustrated rear eject body 12 includes a tailgate actuation system 50 (best shown, for example, in FIGS. 14-28). Advantageously, unlike many rear eject bodies that use separate hydraulic cylinders at the rear of the body to move the tailgate, the tailgate actuation system 50 utilizes a single hydraulic cylinder 20 to operate both the ejector blade 18 and tailgate 16. This reduces the required maintenance as well as the cost of the rear eject body 12 by eliminating the additional hydraulic cylinders, hydraulic lines and hydraulic controls conventionally associated with operating the tailgate. The tailgate actuation system 50 links movement of the tailgate 16 to movement of the ejector blade 18 helping to ensure that the tailgate 16 opens quickly and reliably during dumping. In particular, the actuation of the ejector blade 18 from the fully retracted position to a partially extended position controls the opening and closing of the tailgate 16 at the rear of the rear eject body 12.

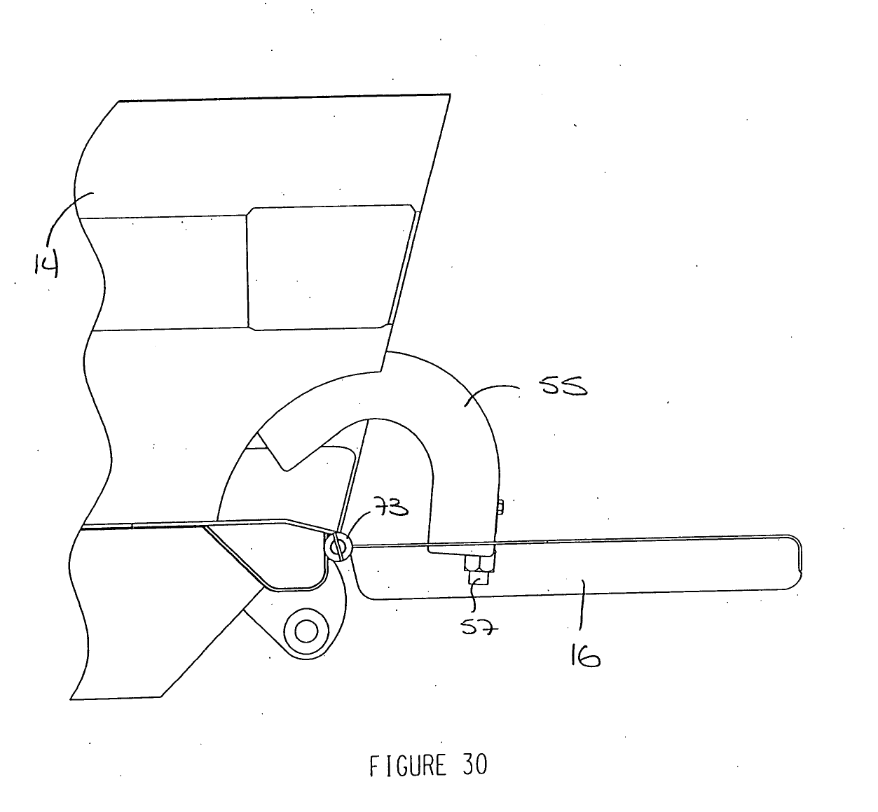

In the illustrated embodiment, the tailgate actuation system 50 includes a release rod 52 to which a chain 54 is attached as shown in FIGS. 14, 16 and 17. The chain 54, in turn, wraps around a chain drum 55 and connects to the tailgate 16. Specifically, in the illustrated embodiment, the chain 54 is connected to the chain drum 55 using a chain tensioner 57 (FIGS. 2, 5, 16, 29, 30 and 32), which is adjustable via a large nut on a threaded rod to ensure that the tailgate 16 fits tightly against the sidewalls 14 of the rear eject body 12 when in the closed position. A tailgate release lever 58 is pivotally mounted on the forward end of the release rod 52. The tailgate release lever 58, rod 52 and chain 54 assembly extends along the outside surface of one or both of the plates of the sidewalls 14 of the rear eject body 12 such as shown in FIG. 14 (for the sake of clarity the outer structure of the sidewall 14 is removed in FIG. 14).

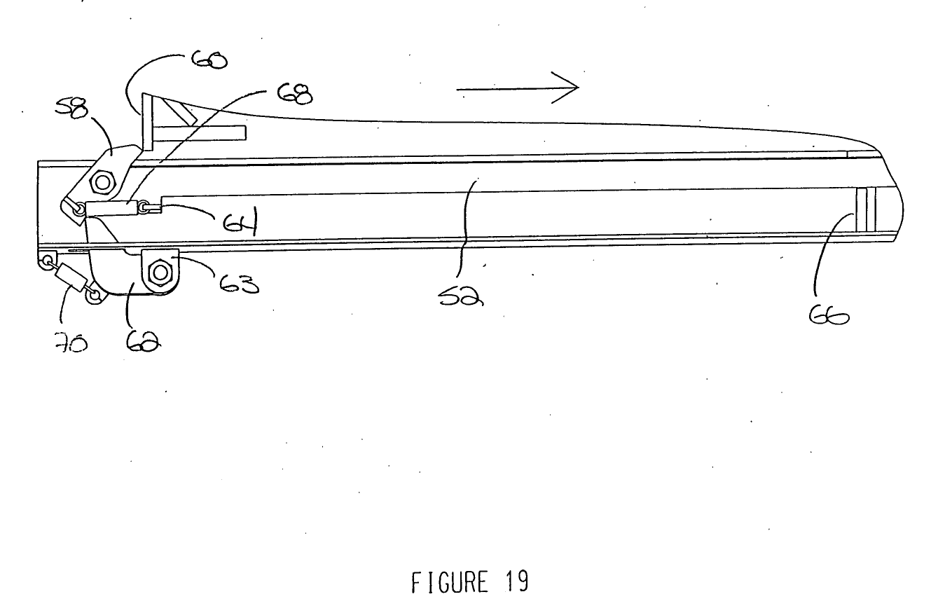

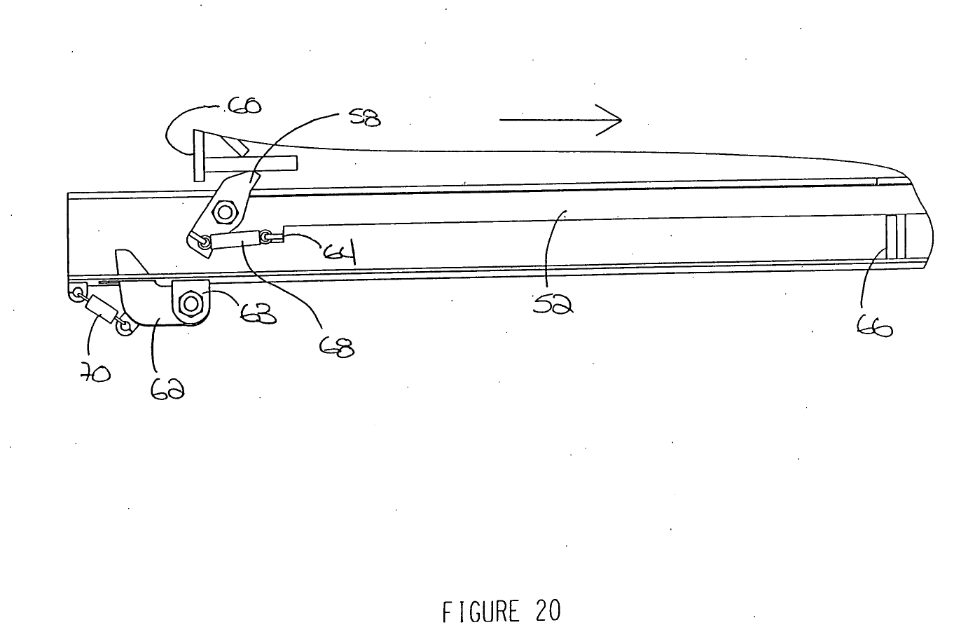

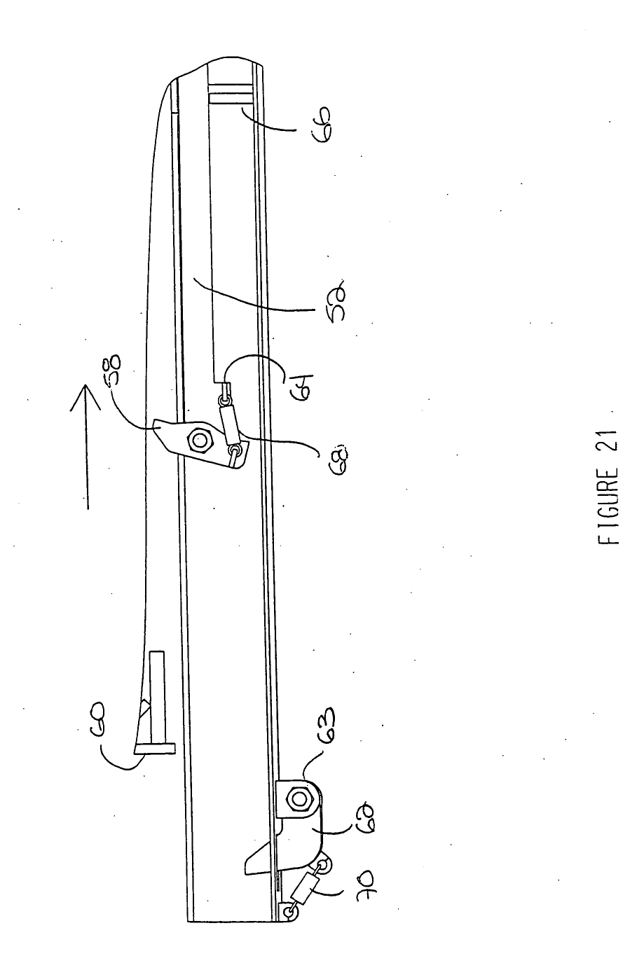

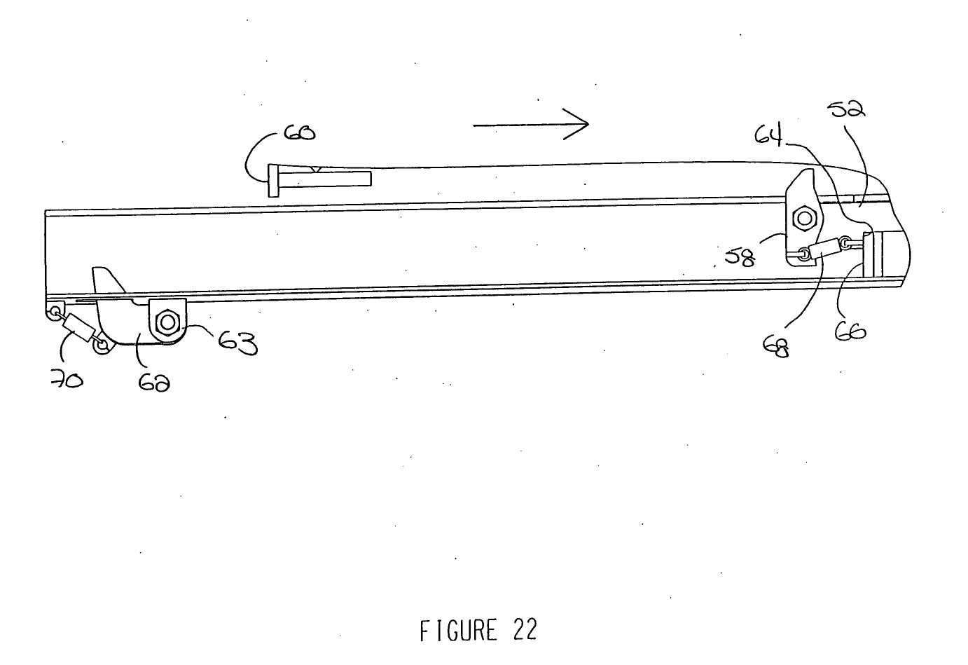

With the ejector blade 18 fully retracted, the tailgate 16 is held closed by the engagement of the tailgate release lever 58 with a stop surface 60 on the ejector blade 18 (see FIGS. 15, 16, and 18). As the ejector blade 18 starts to move rearward in order to eject a load, the release rod 52 starts to slide rearward (pulled by the weight of the tailgate 16) and engages a quick release dog 62 which is pivotally supported via a pair of mounting ears 63 on the sidewall 14 of the rear eject body 12. The engagement of the tailgate release lever 58 with the quick release dog 62 pivots the gate release lever 58 in a clockwise direction (with respect to the drawings) relative to the release rod 52 (see FIG. 19). This disengages the tailgate release lever 58 from the stop surface 60 on the ejector blade 18 (see FIGS. 20 and 21). The release rod 52 then slides rearward until a notch 64 on the release rod 52 engages a stop surface 66 provided in the sidewall 14 of the rear eject body 12 (see FIG. 22). At this point, the tailgate 16 has swung into the fully open position.

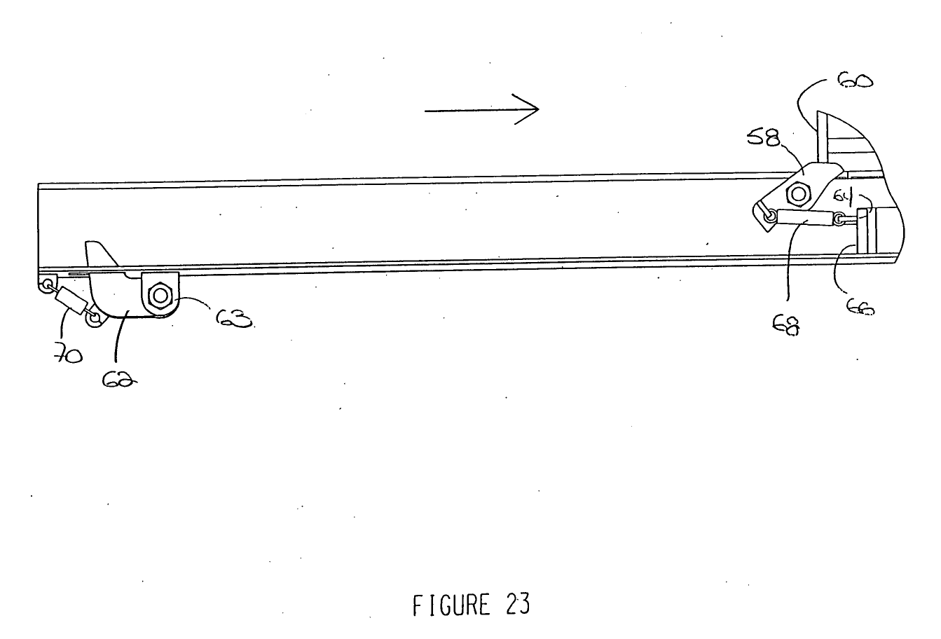

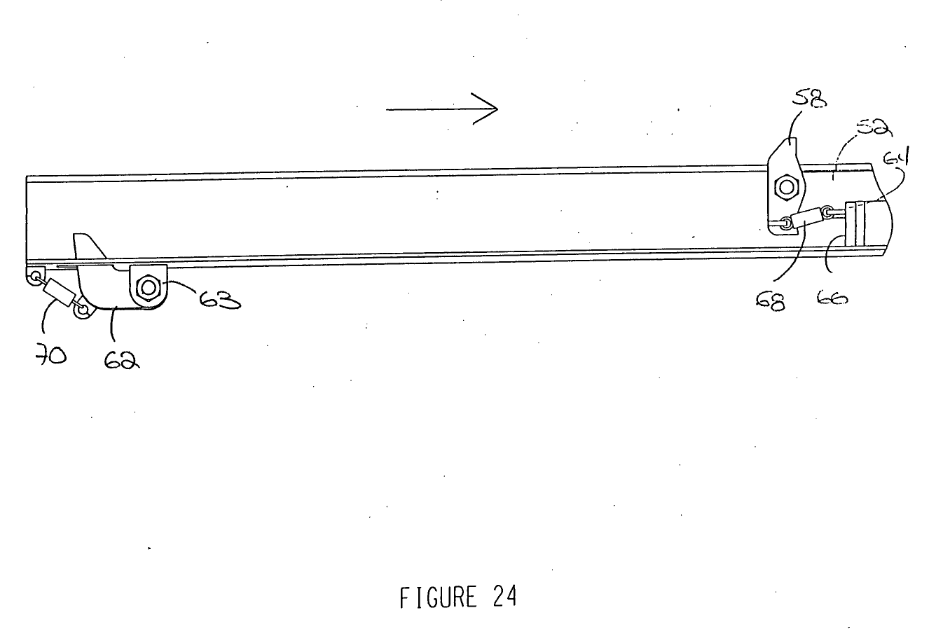

As the ejector blade 18 continues to move rearward to eject the load, the ejector blade 18 again engages the tailgate release lever 58. This pivots the tailgate release lever 58 in the clockwise direction so that the ejector blade 18 can pass by the tailgate release lever 58 (see FIG. 23). Once the ejector blade 18 is past the tailgate release lever 58, a spring 68 which extends between the tailgate release lever 58 and the release rod 52 pivots the tailgate release lever 58 back into a position wherein the tailgate release lever 50 extends perpendicularly relative to the release rod 52 (see FIG. 24).

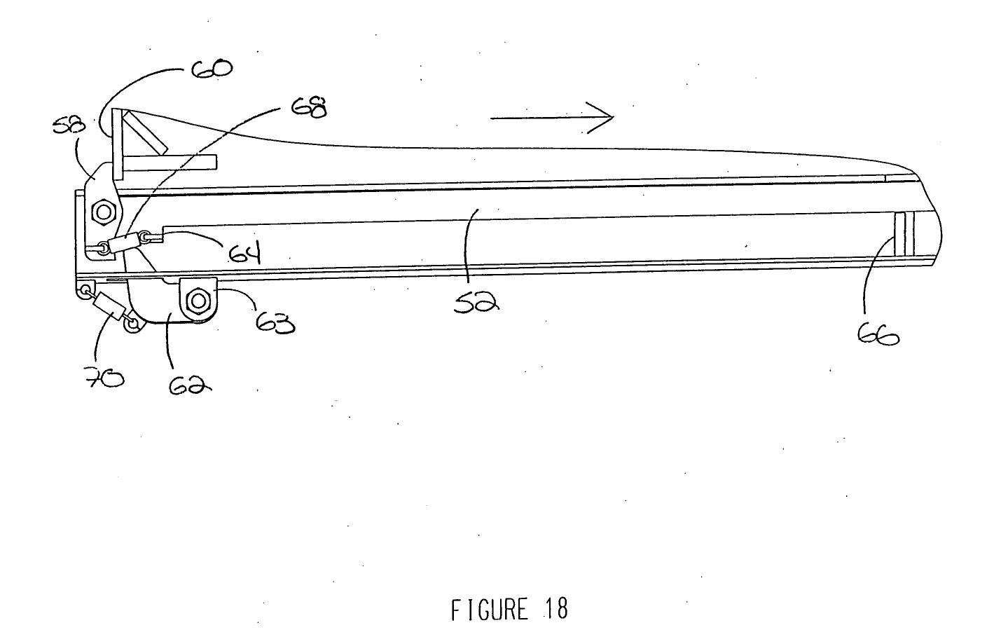

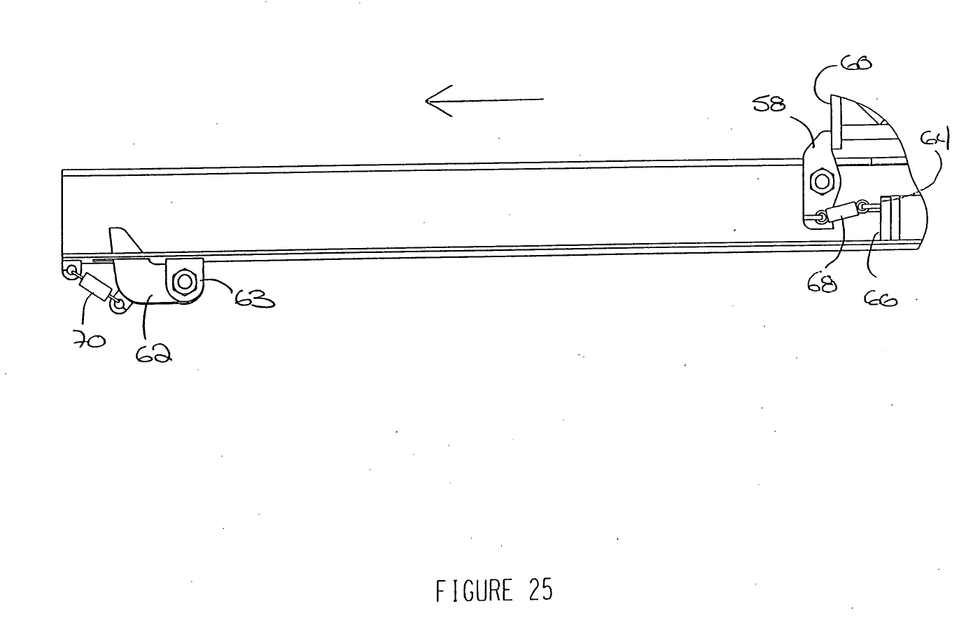

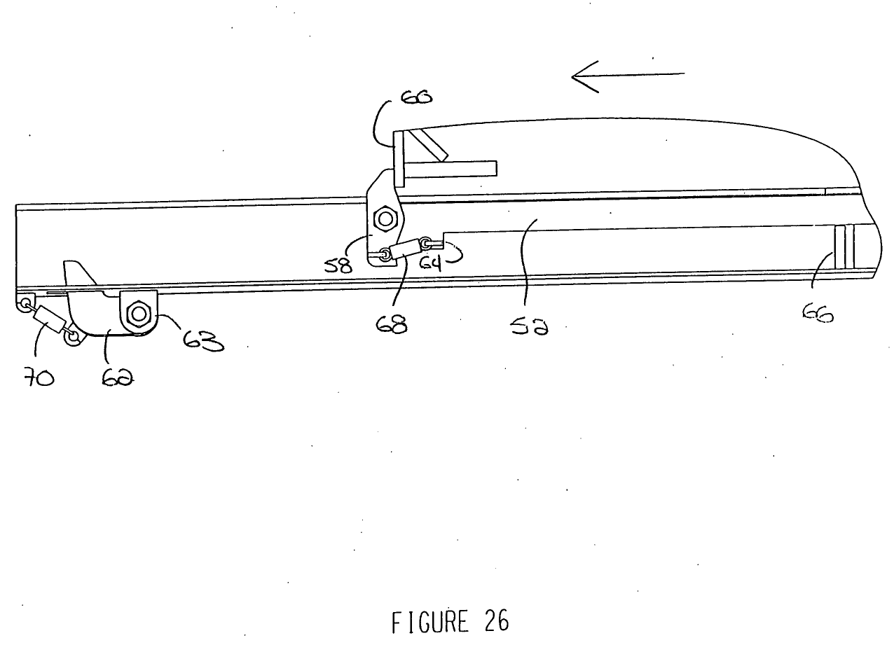

As the ejector blade 18 moves back to the fully retracted position, the stop surface 60 on the ejector blade 18 once again engages the tailgate release lever 58, in this case, when the ejector blade 18 is approximately 80% of the way back to the retracted position (see FIG. 25). The release rod 52 is configured to prevent the tailgate release lever 58 from pivoting past perpendicular in the counter-clockwise direction relative to the release rod 52. Accordingly, when the ejector blade 18 engages the tailgate release lever 58 as the ejector blade 18 returns to the fully retracted position, it pulls the release rod 52 and chain 54 forward (see FIG. 26) and thereby rotates the tailgate 16 back into the closed position. The quick release dog 62 on the sidewall 14 of the rear eject body 12 is pivotal so that the tailgate release lever 58 can move forward past the quick release dog 62 into the fully retracted and closed position (see FIGS. 27, 28 and 18). A spring 70 then pivots the quick release dog 62 inward or clockwise back behind the gate release lever 58 (see FIG. 18).

Advantageously, when a load is being ejected, the tailgate 16 is released and is fully open after very minimal rearward movement of the ejector blade 18 so that the load can be ejected from the rear eject body 12 (e.g., after approximately six inches rearward movement of the ejector blade 18). In the embodiment illustrated in FIGS. 14-28, the ejector blade 18 only needs to move approximately 3-5% of the total ejector blade 18 rearward movement to fully release the tailgate 16. In contrast, 17-25% of the total ejector blade 18 forward or retraction movement is used to move the tailgate 16 into the closed position.

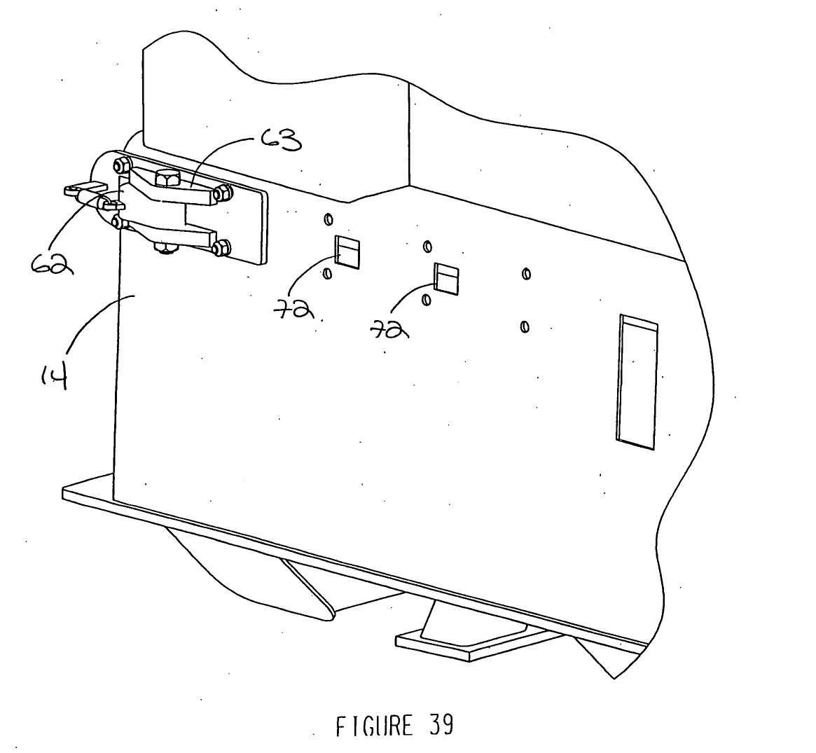

As best shown in FIGS. 12, 13 and 39, the rear eject body 12 can be configured so that the quick release dog 62 that allows for “quick” release of the tailgate 16 can be positioned in any one of a plurality of positions. This permits adjustment of the rearward distance the ejector blade 18 moves before the tailgate 16 is released to fully open. In this case, the quick release dog 62 can be positioned in one of four different positions each of which is a different distance from the forward end of the rear eject body 12. Mounting holes for a plate which carries the mounting ears 63 for the quick release dog 62 are provided at each of the mounting positions. A corresponding cutout 72 in the sidewall 14 of the rear eject body 12 is provided for each of the mounting positions (the cutout for the second mounting position from the front is covered by the mounting ears plate in FIG. 39). These cutouts 72 provide the openings through which the quick release dog 62 would operate to release the tailgate 16 at the various release points. Positioning the quick release dog 62 in the mounting ears 63 closest to the forward end of the rear eject body 12 releases the tailgate 16 to the fully open position the quickest, i.e. after the shortest movement of ejector blade 18. In contrast, positioning the quick release dog 62 in the mounting ears 63 furthest from the forward end of the rear eject body 12 releases the tailgate 16 to the fully open position the slowest, i.e. after the greatest movement of the ejector blade 18 and after the tailgate 16 has already pivoted, as a result of the ejector blade movement, a significant distance towards the open position.

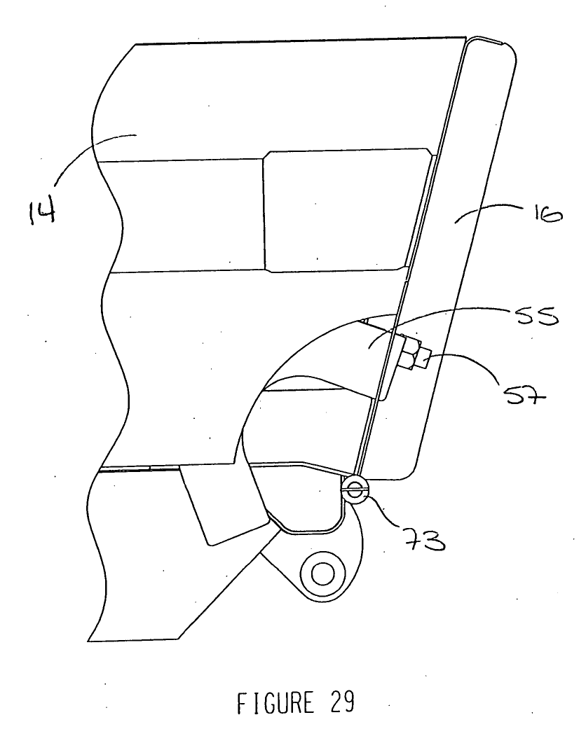

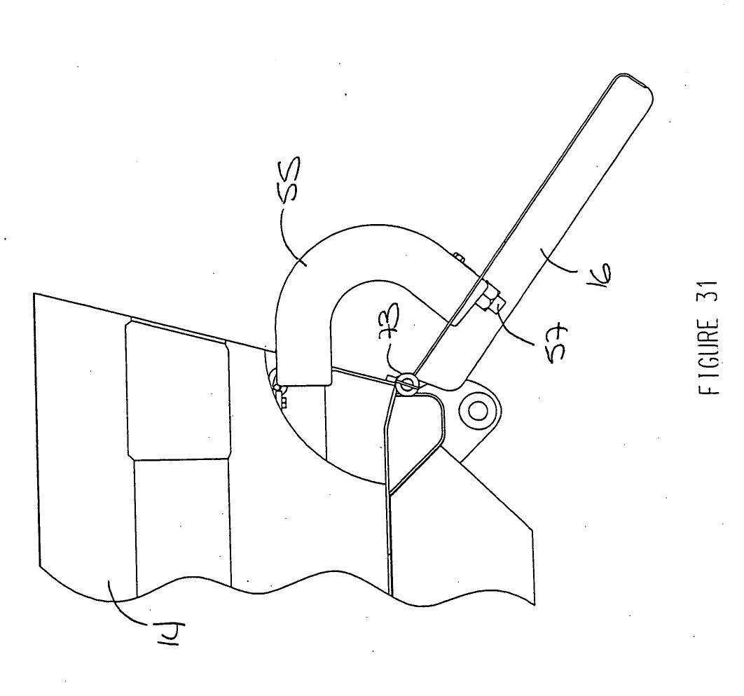

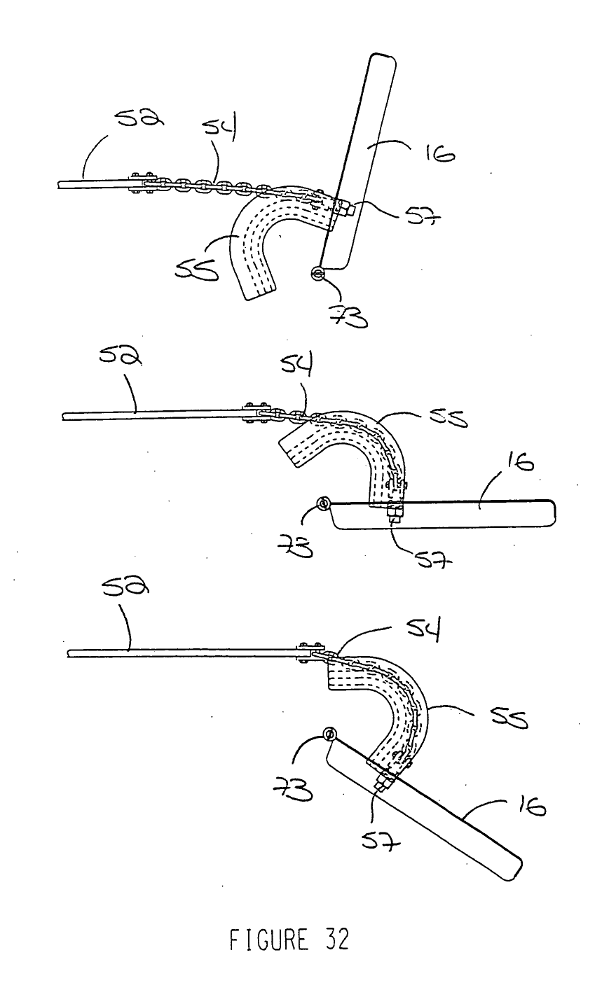

To reduce the force that has to be applied to the ejector blade 18 to rotate the tailgate 16 from the open to the closed position, the tailgate actuation system 50 can be configured so as to vary the torque applied to the tailgate 16 as the tailgate 16 moves between the open and closed position. When closing the tailgate 16, the amount of force required to move and close the tailgate 16 is greatest when the tailgate 16 is in a horizontal position. Once past the horizontal position, the amount of force required to move the tailgate 16 decreases as the tailgate 16 approaches a vertical position over the tailgate pivot point 73. In the embodiment illustrated in FIGS. 29-32, the varying of the torque is achieved by providing a chain drum 55 having a varying radius such that the moment arm acting on the tailgate 16 from the retraction of the ejector blade 18 varies depending on the tailgate position. The moment arm is the perpendicular distance between the line of action (force) created by the ejector blade acting on release rod 52 and the tailgate pivot point 73. The chain drum 55 provides a curved surface around which the chain 54 acts to apply a moment or torque on the tailgate 16. The chain drum includes a first end that is slidably received in the sidewall 14 of the rear eject body 12 and a second end that is connected to the tailgate 16. In this case, the radius of curvature of the chain drum 55 varies between the first and second ends of the drum such that distance between the chain's line of action and the tailgate pivot point 73 varies depending on the position of the tailgate. Specifically, as best shown in FIG. 32, the radius of curvature of the chain drum 55 varies such that the radius of actuation or moment arm on which the chain 54 acts to rotate the tailgate 16 is greatest (i.e., the chain's line of action is the furthest distance from the tailgate pivot point 73) when the tailgate 16 is in a horizontal position and the greatest torque is required to rotate the tailgate 16. In turn, the moment arm on which the chain 54 acts is less (i.e., the chain is a relatively shorter distance from the tailgate pivot) when the tailgate 16 is being held in the closed position and when it first starts leaving the fully open position because less torque is required to rotate the tailgate 16 as it is just beginning to leave the fully open position.

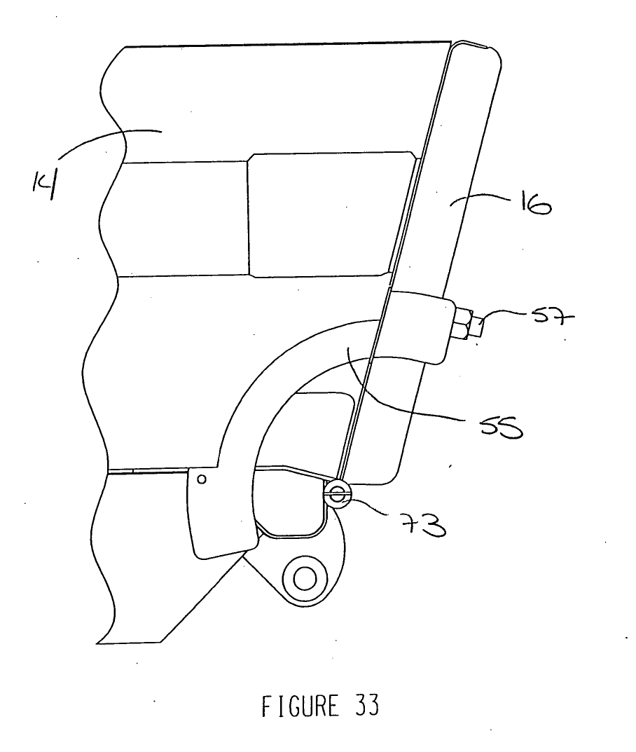

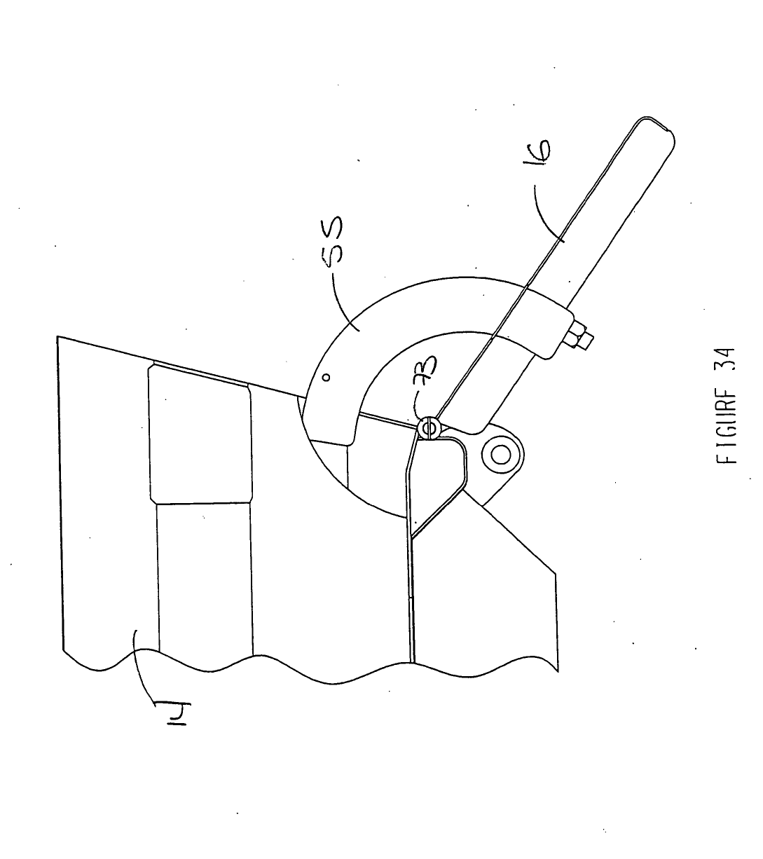

In an alternative embodiment, the chain drum 55 could be arranged and configured such that it has a constant radius of actuation but has a center of rotation that is different than the tailgate pivot point 73 as shown in FIGS. 33 and 34. With this arrangement, the smallest moment arm for the chain 54 is provided when the tailgate 16 is in the fully open position and the greatest moment arm for the chain 54 is provided when the tailgate 16 is nearly fully closed. Accordingly, less force would have to be applied to the chain 54 in order to hold the tailgate 16 in the closed position.

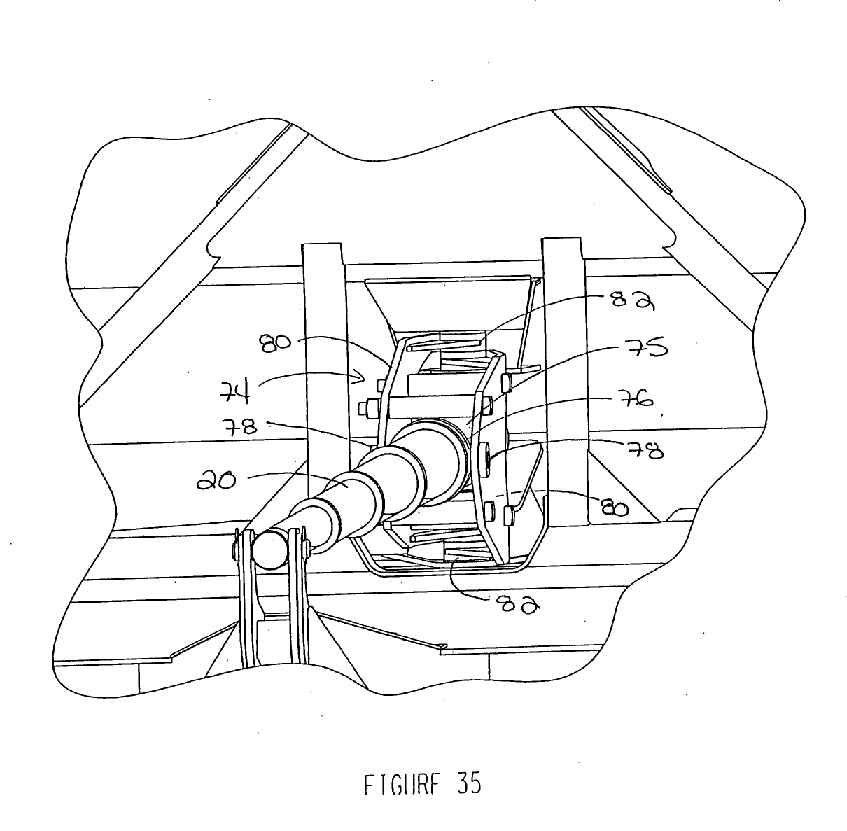

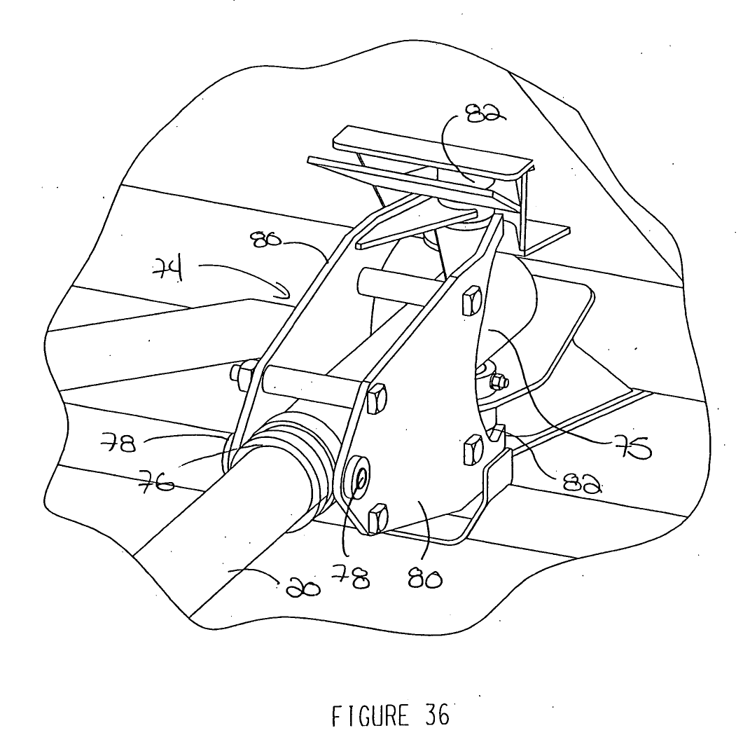

To prevent any twisting movement of the ejector blade 18 from inducing forces into the hydraulic cylinder 20, a hydraulic cylinder mounting arrangement can be provided which permits movement of the ejector blade 18 relative to the hydraulic cylinder 20. In the illustrated embodiment, the hydraulic cylinder mounting arrangement comprises a cylinder trunnion mount 74 as best shown in FIGS. 35 and 36. The cylinder trunnion mount 74 is provided at the forward or rod end of the cylinder barrel 75 of the hydraulic cylinder 20 in order to counterbalance the weight of the cylinder barrel 75 and extended cylinder rod at full hydraulic cylinder extension. The cylinder trunnion mount 74 includes a collar 76 that surrounds the hydraulic cylinder barrel 75. A pair of stub shafts 78 protrude from the collar 76 and are received in a pair of laterally spaced apart plates 80 that are supported on the ejector frame 22. This arrangement allows the hydraulic cylinder 20 to pivot up and down relative to the ejector blade 18. Additionally, the ejector blade 18 may rack or twist slightly side-to-side as it slides back and forth in the rear eject body 12 (e.g., less than an inch on either side of the ejector blade 18). To account for this movement, the cylinder mounting arrangement also has a vertical axis of rotation. In particular, as best shown in FIG. 36, the laterally spaced plates 80 to which the hydraulic cylinder 20 is mounted are connected at their rearward upper and lower ends to a respective pair of vertically extending pivots 82 that are supported on the ejector blade frame 22. These pivots 82 permit the hydraulic cylinder 20 (along with the laterally spaced plates 80) to rotate about a vertical axis defined by the two pivots 82. If the two pivots 82 are arranged so that the vertical axis of rotation is located at or near the neutral point of any side-to-side twisting of the ejector blade 18, side-to-side twisting of the hydraulic cylinder 20 is virtually eliminated. In this case, the vertical axis defined by the two pivots 82 is arranged at the rearward end of the hydraulic cylinder barrel. With this arrangement, the hydraulic cylinder 20 pulls on the ejector blade 18 as it extends or ejects the load in such a way as to produce a centering action on the ejector blade 18.

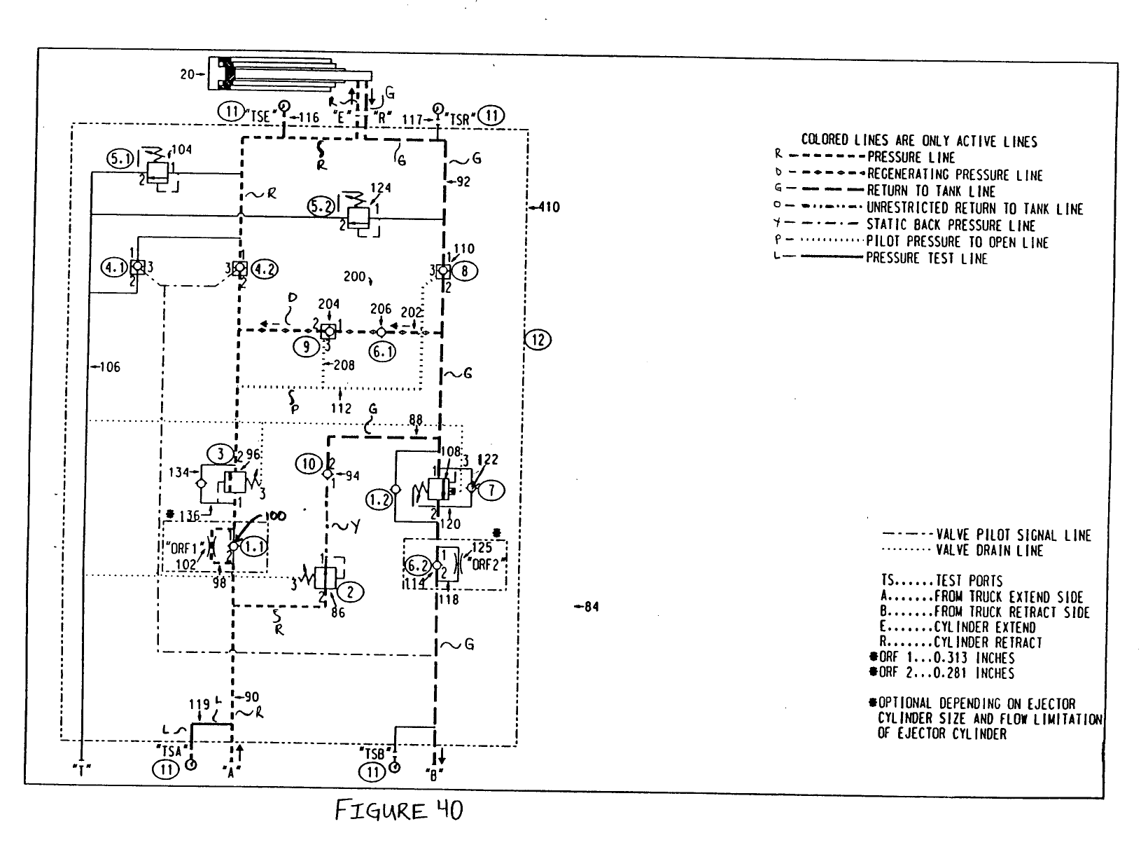

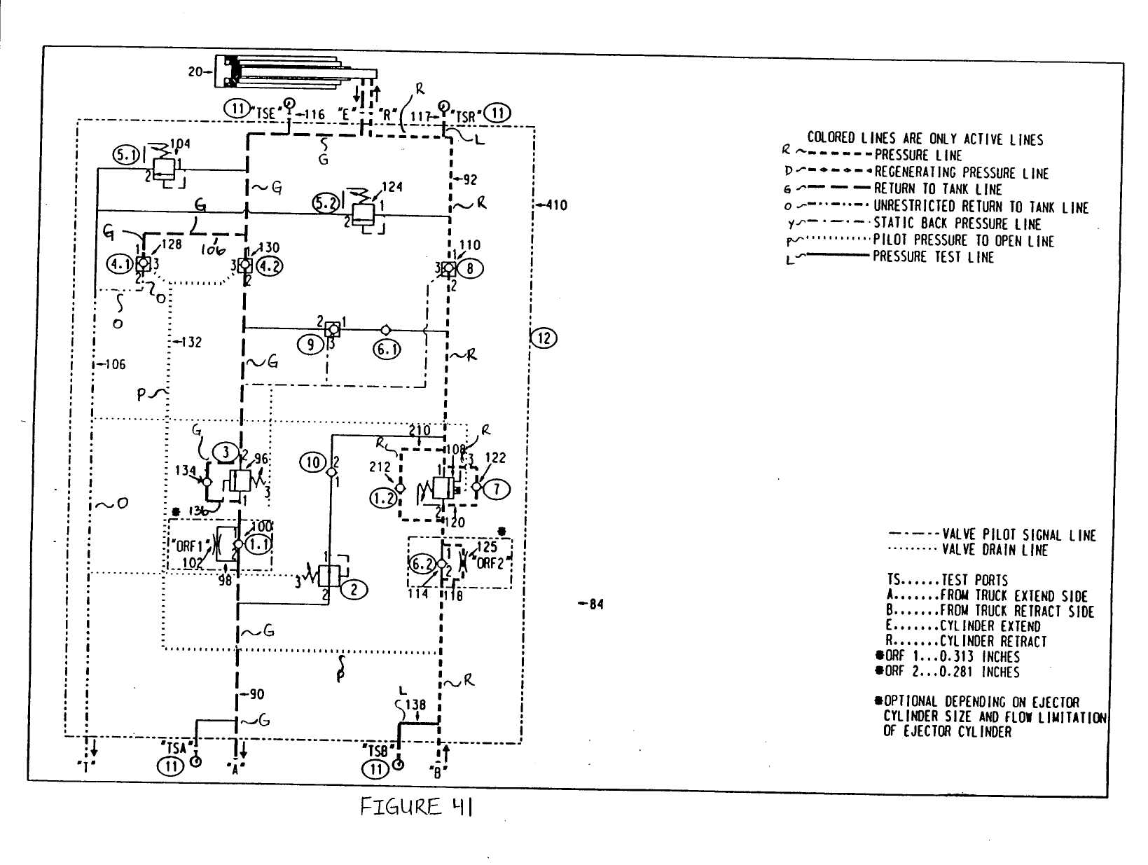

The illustrated rear eject body 12 can further include a hydraulic control system such as shown in FIGS. 40 and 41. The illustrated hydraulic control system controls extension and retraction of the hydraulic cylinder 20 and, in particular, prevents misfiring of the cylinder. The misfire phenomena in double-acting, multi-stage telescopic cylinders can occur on cylinder extension when one of the smaller diameter stages is partially extended out of sequence, blocking the retract oil flow out of a larger diameter stage back to tank on the retract side of the hydraulic cylinder. It is a phenomenon that is well-known to manufacturers of multi-stage, double-acting telescopic cylinders. By creating a positive backpressure on the hydraulic cylinder 20 retract segments or in the retract pressure line as the hydraulic cylinder 20 is extended, the hydraulic control system 84 keeps the multi-stage telescopic sections of the hydraulic cylinder 20 in sequence and prevents misfiring of the cylinder.

The flow of oil to the hydraulic control system can be controlled, for example, by the conventional 3-position, 4-way hydraulic valve that is typically provided on the type of off-highway trucks on which the rear eject body 12 could be installed. The operation of the hydraulic control system during extension and retraction of the hydraulic cylinder 20 is shown in FIGS. 40 and 41 respectively. In FIGS. 40 and 41, the active lines of the hydraulic control system are shown in bold and in color with the valve drain lines being indicated by dotted lines and the active valve pilot pressure lines being indicated by dashed lines. Also, in FIGS. 40 and 41, arrows at each of the active ports indicate hydraulic fluid flow into and out of the hydraulic control system.

Drawings 40-47 contain a color-coded key that provides additional information concerning certain portions of the lines that are thicker or bolder than other portions and shown in color. To the extent practical, the corresponding colored thicker or bolder portions have been marked with R for red, D for dark blue, G for green, 0 for orange, P for purple, Y for yellow, and L for light blue. However, it is recommended that a color copy of the submission should be referred to see the information more clearly.

Referring to FIGS. 40-47, there is shown modified forms of the hydraulic control systems described in LeRoy Hagenbuch's U.S. published patent application 20030223849, published on Dec. 4, 2003 (filed on Feb. 25, 2003) and in WIPO publication WO03072392 A3, both of which are incorporated herein by reference. These hydraulic control systems 84 include a regenerating feature that can provide a higher hydraulic inflow (than can be achieved using a hydraulic pump alone) during extension of the ejector blade by causing the hydraulic fluid that exits the retract side (of the hydraulic cylinder 20) to flow back into the extend line 90. The higher flow is advantageous for use with a hydraulic cylinder 20 that has a larger diameter than certain previous designs (in order to provide a higher retraction force on the ejector blade). A larger diameter hydraulic cylinder 20 requires a much higher hydraulic inflow to eject the load from a rear eject body within a desired time. A regenerative feature is useful when the hydraulic pump does not have a high enough capacity to extend the hydraulic cylinder 20 in the desired time. In certain trucks, the output flow of the hydraulic dump circuit (which can be used as the hydraulic pump for hydraulic control system 84) cannot, alone, provide the inflow needed to eject the load in a timely manner.

For example, some trucks have a hydraulic dump circuit output that has a hydraulic fluid flow of approximately eighty gallons per minute. However, as seen in the upper left hand corner of in FIG. 40, an extend hydraulic flow of 117.5 gallons per minute is required to achieve a 14 second extension time for hydraulic cylinder 20. In this case, the retract side has an outflow of 42.85 gallons per minute. Subtracting the 42 from the 117 we come up with approximately 80 gallons per minute of additional in flow needed to extend the hydraulic cylinder in 14 seconds. Therefore, if the truck has a hydraulic dump circuit output that is approximately 80 gallons a minute, then adding the approximately 80 gpm and the 42.85 gpm comes up with close to the 117.5 gallons per minute needed to extend the hydraulic cylinder in approximately 14 seconds by using utilizing. the flow from the retract side of cylinder 20.

Referring now to FIG. 40, during extension of the hydraulic cylinder 20, pressurized hydraulic fluid is first directed into the hydraulic control system 84 through port A. The hydraulic fluid is directed to a pressure reducing valve 86 which is located in a backpressure line that connects the extend and retract lines 90 92 of the hydraulic control system. The pressure reducing valve 86 reduces the inlet pressure from a standard supply pressure (e.g., about 3000 psi) to a predetermined lower pressure (e.g., about 800 psi). From the pressure reducing valve 86, the hydraulic fluid is directed through a check valve 94 and back pressure line 88 that permits the flow of hydraulic fluid into the retract line 92 (which during cylinder extension is the return to tank line) at the predetermined reduced pressure (e.g., approximately 800 psi).

From port A, hydraulic fluid is also directed to a sequence valve 96 located in the extend line 90 after passing through a bypass line 98 around a check valve 100 that blocks flow from port A. The bypass line 98 includes an orifice 102 which restricts or throttles the rate of hydraulic fluid flow into the extend line 90. (In one form, orifice 102 is only used when the hydraulic oil supply flow substantially exceeds 90 gpm). In the illustrated embodiment, the hydraulic fluid flow into the extend line 90 is throttled because the trucks on which the rear eject body 12 would typically be mounted produce flow rates into the hydraulic control system 84 that are higher than needed for the hydraulic cylinder 20 to handle. Of course, if the fluid flow rate produced by the truck is in the range that is needed by the hydraulic cylinder 20, the throttling orifice 102 could be eliminated. The sequence valve 96 is configured to block the flow of hydraulic fluid into the extend side of the hydraulic cylinder 20 until the pressure reaches a predetermined value. For example, the sequence valve 96 can be set to open when the pressure reaches approximately 1000 psi. Thus, until the hydraulic fluid from port A reaches a pressure of 1000 psi in the extend line 90, all the hydraulic fluid is diverted through the pressure reducing valve 86 and the backpressure line 88 to produce, in this case, 800 psi of backpressure in the retract side of the hydraulic cylinder 20. This forces the telescopic sections of the retract side of the hydraulic cylinder 20 to be collapsed or retracted in sequence so that as the hydraulic cylinder 20 is extended, the various hydraulic cylinder stages extend in the proper sequence and misfiring is prevented.

Once the pressure in the extend line reaches the predetermined value (e.g., 1000 psi), the sequence valve 96 opens allowing hydraulic fluid to flow directly to the extend side of the hydraulic cylinder 20. This causes the hydraulic cylinder 20 to extend. A pressure relief valve 104 is provided in communication with the extend line 90 that directs hydraulic fluid back to a hydraulic fluid reservoir or tank provided on the truck through tank line 106 when the pressure in the extend line exceeds a predetermined value (e.g., exceeding 2000 psi, such as 2200-2300 psi) such as at the end of the hydraulic cylinder stroke.

In the meantime, as the hydraulic cylinder 20 extends, hydraulic fluid is being forced out of the retract side of the hydraulic cylinder 20 into the retract or return line 92. The check valve 94 in the backpressure line 88 prevents that hydraulic fluid from flowing back into the extend line 90 or port A. Instead, the hydraulic fluid forced out of the retract side of the hydraulic cylinder 20 as it extends, is directed either through regenerative circuit 200 (back to the extend line) or to a counterbalance valve 108 in the retract line 92. The counterbalance valve 108 blocks the flow of hydraulic fluid to port B or back to tank until the pressure reaches a predetermined value, for example 1000 psi., and thus the hydraulic fluid must flow through regenerative circuit 200 prior to such pressure being exceeded.

Once the hydraulic pressure in the retract line 92 exceeds the predetermined value (e.g., 1000 psi), the counterbalance valve 108 opens and allows hydraulic fluid flow to flow to the tank or reservoir through port B. A check valve 114 is arranged in the retract line 92 between port B and the pressure operated check valve 110. However, the check valve 114 is oriented to allow unrestricted hydraulic fluid flow back to port B. In FIG. 52, lines 116, 117, and 119 are test lines for pressure points at which the hydraulic fluid pressure could be tested during extension of the hydraulic cylinder 20.

In order to increase the flow of hydraulic fuel while the hydraulic cylinder 20 is extended, a regenerative hydraulic circuit 200 is included. As hydraulic cylinder 20 is being extended, regenerative hydraulic circuit 200 causes oil coming out of the retract side (of the hydraulic cylinder 20) to be directed (because of differential oil pressures between the extend and retract sides of the cylinder) into the extend side of the cylinder. Differential pressures exists between the extend side and retract side of the hydraulic cylinder 20 (as the cylinder extends) because the differences in the relative area of the extend and retract sides (of cylinder 20) that the hydraulic oil is operating against. For example, the first stage or first plunger of the hydraulic cylinder 20 could have an extend area that is 74.66 square inches and the retract area could be 24.40 square inches. This means that at a hydraulic pressure of only (24.40/74.60×2,000 p.s.i. retract pressure=654 extend pressure) 654 p.s.i. in the extend side of the hydraulic cylinder 20, a hydraulic pressure of 2,000 p.s.i. is created in the retract side of the hydraulic cylinder 20.

Regenerative circuit 200 includes regenerative line 202 that connects the retract side of the hydraulic cylinder 20 to extend line 90 through a pressure operated check valve 204 and a check valve 206. The check valve 206 only allows flow in one direction in this line, i.e. from the retract side of the cylinder to the extend side (to help prevent the cylinder from drifting open unintentionally). In one form, pressure operated check valve 204 is a pressure to open check valve that opens based on a pilot pressure signal from extend line 90 through pilot line 208. In simple terms, the extend line 90 (that goes to the extend side of the cylinder) is connected with the retract line 92 (that goes to the retract side of the cylinder) through a regenerative line 202 and pressure operated check valve 204. When the cylinder is extending, oil comes from the retract side of the cylinder (that would normally flow back to tank) and flows into the extend side of the cylinder through regenerative circuit 200.

However, when the cylinder is retracting, the signal pressure coming from the extend input pressure line 90 (through pilot line 208) to the pressure operated check valve 204 and is not large enough to cause pressure operated check valve 204 to open and prohibits oil from flowing from the retract side of the cylinder to the extend side of the cylinder.

Pressure relief valves 104 (and 124) direct hydraulic fluid back to a hydraulic fluid reservoir or tank when the pressure in extend line 90 (or 92) exceeds approximately 2000 psi (although in reality, the pressure relief valve typically operates under a range of pressure, such as 1800-2300 psi.).

Pressure operated check valve 204 is also sometimes referred to as a pilot to open hydraulic valve because when a certain pilot pressure is applied to the valve, it opens. When the pressure in pilot line 208 is equal to or greater than the pressure in extend line 92 then pressure operated check valve 204 will normally open and fluid will flow through regenerative circuit 200.

In sum, when hydraulic fluid is applied to the hydraulic control system in order to extend the hydraulic cylinder 20, pressure first builds in the retract line 92 to 800 psi. When the pressure in line 90 exceeds 1000 psi, the sequence valve 96 opens and allows the hydraulic fluid to flow to the extend side of the hydraulic cylinder 20. This forces the hydraulic oil out of the retract side of the cylinder into the regenerative circuit 200 and back into the extend side when the pressure in the cylinder extend line is less than 1000 psi. However, when the retract line 92 builds to a pressure of 1000 psi, then the counterbalance valve 108 opens and also allows hydraulic fluid to flow back through port B to the tank. The pressure relief valve 104 directs the hydraulic fluid back to the tank if the pressure in the extend line 90 exceeds the predetermined value to which the relief valve 104 is set.

Referring now to FIG. 41, when the hydraulic cylinder 20 retracts, hydraulic fluid enters through port B and is directed through the retract line 92 to the check valve 114. This check valve 114 is oriented to block the flow of hydraulic fluid from port B so that the hydraulic fluid is directed through a bypass line 118. The bypass line 118 includes an orifice 125 that restricts the flow of hydraulic fluid into the retract side of the hydraulic cylinder 20. (In one form, orifice 125 is only used when the hydraulic oil supply flow substantially exceeds 90 gpm). The hydraulic fluid then flows to the pressure-operated check valve 110, which is a one-way check valve oriented to allow unrestricted flow from port B through extend line 92 and through counterbalance valve 108. A bypass line 120 is provided around the counterbalance valve 108. The bypass line 120 includes a check valve 122 that permits unrestricted hydraulic fluid flow from port B to reach the retract side of the hydraulic cylinder 20 (during extension of the hydraulic cylinder, the check valve 122 blocks flow towards port B forcing the hydraulic fluid through the counterbalance valve 108). A pressure relief valve 124 is provided in communication with the retract line 92 which directs the hydraulic fluid back to the tank through the tank line 106 when the pressure in the retract line 92 exceeds a predetermined value (e.g., exceeding 2000 psi, such as 2300-2400 psi) such as at the end of the hydraulic cylinder retraction stroke.

Since the piston area found in the extend side of the hydraulic cylinder 20 is substantially greater than the piston area found in the retract side (e.g., approximately seven times greater), when the cylinder is being retracted the hydraulic fluid that is being pushed out of the extend side of the hydraulic cylinder 20 must be allowed to return to the tank in a fairly unrestricted manner. Accordingly, as hydraulic fluid is flowing to the retract side of the hydraulic cylinder 20, a pair of pressure operated check valves 128, 130 in the tank line 106 open based on a pilot pressure signal from the retract line 92 through pilot line 132. The opening of these pressure-operated check valves 128, 130 allows unrestricted flow of oil from the extend side of the hydraulic cylinder 20 to the tank. At the same time, the hydraulic fluid from the extend side can also flow via the extend line back to port A and on to the tank. In particular, the flow in the extend line 90 back to port A proceeds through a check valve 134 in a bypass line 136 around the sequence valve 96 and through the check valve 100 arranged parallel to the bypass line 98 with the flow restricting orifice 102. Both of these check valves 134, 100 are arranged to allow unrestricted hydraulic fluid flow back to port A. In FIG. 41, lines 116, 117 and 138 are test lines for pressure points at which the pressure could be tested during retraction of the hydraulic cylinder 20.

When the hydraulic cylinder is being retracted, the hydraulic fluid flow from the extend side of the hydraulic cylinder 20 back to the tank should be unrestricted in order to prevent backpressure in the extend side of the hydraulic cylinder 20 from stalling retraction of the hydraulic cylinder 20. In particular, because of the much larger piston area on which the extend side pressure acts as compared to the retract side pressure, even a minimal back pressure in the extend side can offset the retract pressure and stall the hydraulic cylinder 20. For example, the ratio of the extend side area to the retract side area can be approximately 8:1. Thus, any backpressure in the extend side of the hydraulic cylinder 20 is multiplied by a factor of 8 when determining the force that is being applied against the retract pressure. In such a case, a pressure of 2400 psi in the retract side can be offset by a backpressure of only 300 psi in the extend side of the hydraulic cylinder 20, effectively stalling retraction of the hydraulic cylinder 20. With the illustrated hydraulic control system, when retracting the hydraulic cylinder 20, the pressure operated check valves 128, 130 allow a free unrestricted flow of oil out of the extend side of the hydraulic cylinder 20 and back to the tank, thereby minimizing the backpressure in the extend side of the cylinder 20.

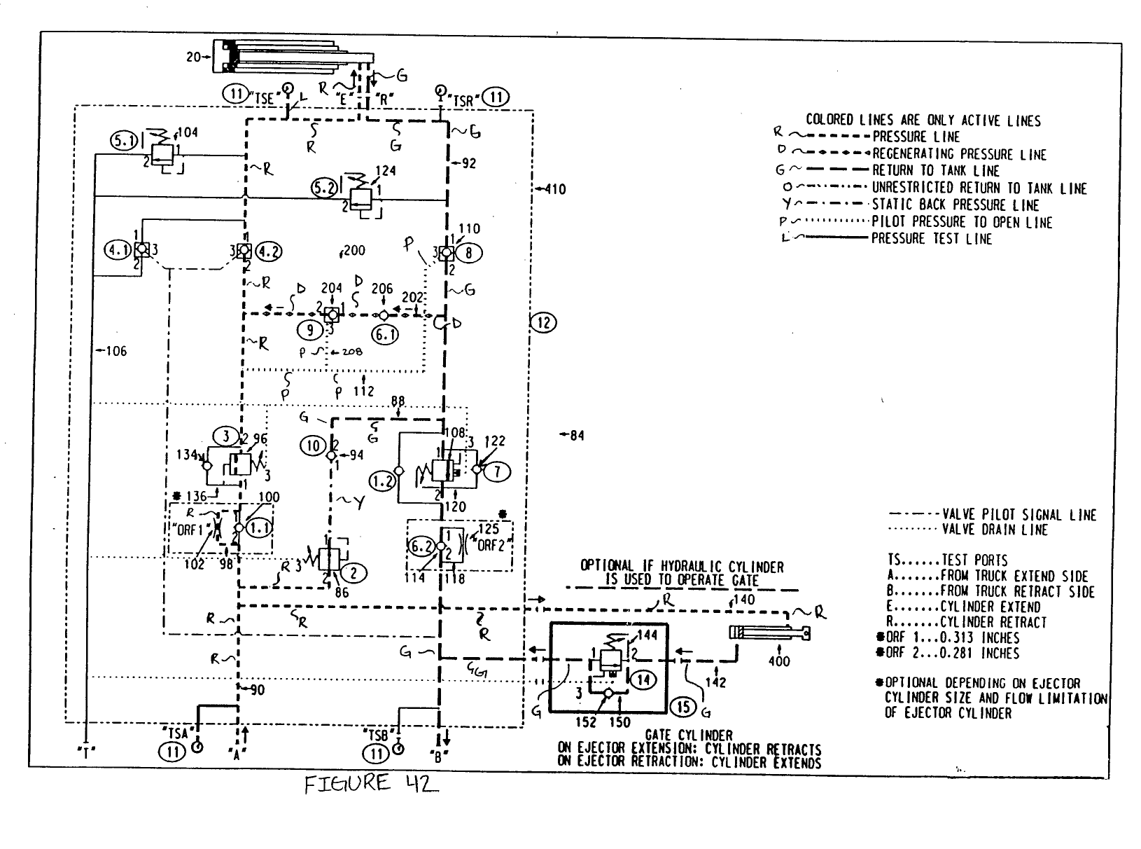

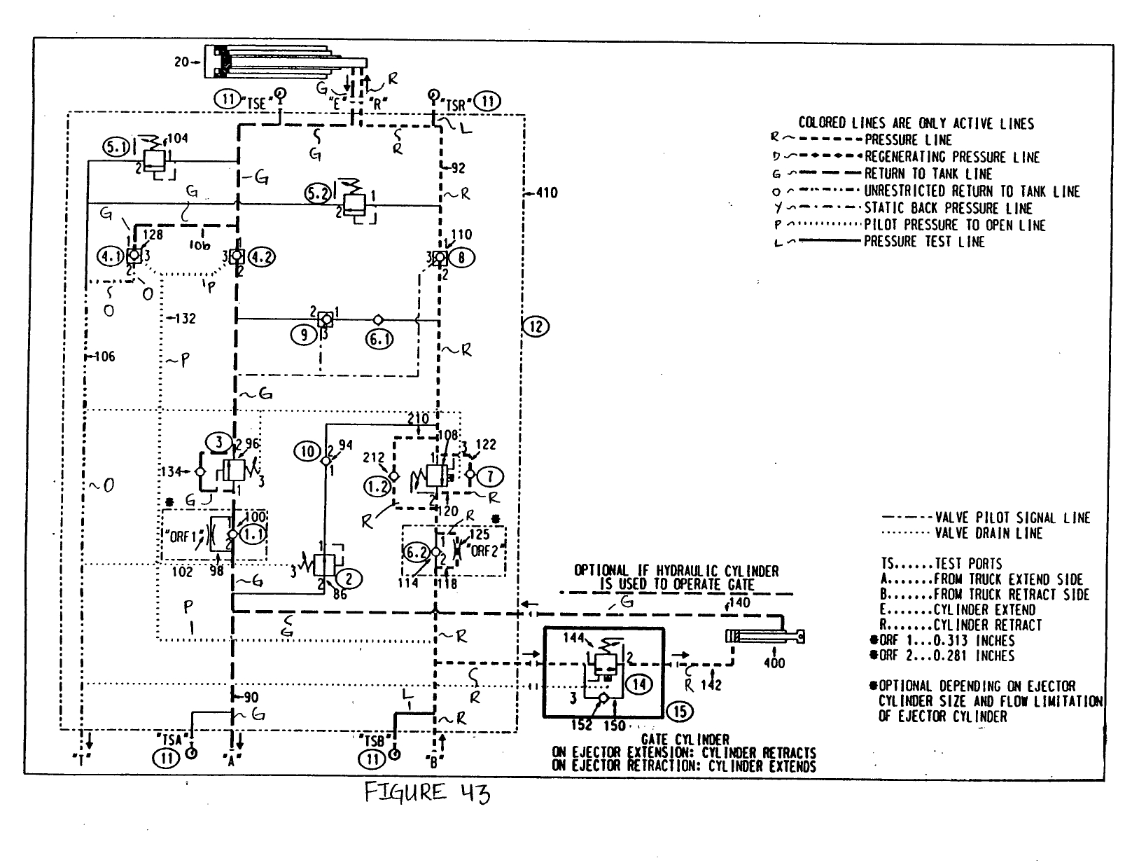

Optionally, instead of utilizing the illustrated tailgate actuation system 50, movement of the tailgate 16 between the open and closed positions can be effected by one or more tailgate cylinders 400 (one shown). Advantageously, the hydraulic control system 84 can be modified to also control the extension and retraction of these tailgate cylinders 400 as shown in FIGS. 42 and 43. In this case, the tailgate cylinders 400 are arranged such that retraction of the tailgate cylinders opens the tailgate 16. Thus, in order to move the tailgate 16 into the open position when the hydraulic cylinder 20 is extended, the common retract line 140 for the tailgate cylinders is connected to the extend line 90 for the hydraulic cylinder 20.

To ensure that the tailgate 16 opens early in the eject cycle, the retract line 140 for the tailgate cylinders is tied into the extend line 90 of the hydraulic cylinder 20 before the sequence valve 96. Moreover, the sequence valve 96 can be set to a higher pressure setting. For example, the sequence valve could be set to open at 2300 psi as compared to a 1000 psi setting used when the hydraulic control system 84 only controls the hydraulic cylinder 20. Until the sequence valve 96 opens, the flow of hydraulic fluid to the extend side of the hydraulic cylinder 20 is blocked and pressure builds in the retract side of the tailgate cylinder 400 causing the tailgate 16 to open. The hydraulic fluid that is forced out of the extend side of the tailgate cylinders 400 flows through a tailgate cylinder extend line 142 that ties into the retract line 92 upstream of the relief valve 124. Since the hydraulic fluid in the retract side of the hydraulic control system 84 is not at a high enough pressure to open the relief valve 124, the hydraulic fluid from the extend side of the tailgate cylinders 400 travels through a check valve 152 in a bypass line 150 around the sequence valve 144 and into the retract line 92 of the hydraulic cylinder 20, thereby allowing the fluid to return to tank through port B.

Referring to FIG. 43, during retraction of the hydraulic cylinder 20, the sequence valve 144 blocks the flow of hydraulic fluid into the extend side of the tailgate cylinders until the pressure in the hydraulic cylinder retract line 92 reaches a predetermined pressure. In particular, the sequence valve 144 is set to open at pressure lower than the relief valve 124 pressure selling. When the pressure in the hydraulic cylinder retract line 92 reaches the predetermined pressure, the sequence valve 144 opens allowing hydraulic fluid to flow into the extend line 142 of the tailgate cylinder, causing the tailgate 16 to close. The sequence valve 144 thus delays the closing of the tailgate 16 until the ejector blade 18 has started moving towards the retracted position. The hydraulic fluid that is forced out of the retract side of the tailgate cylinders flows through the tailgate cylinder retract line 140 into the hydraulic cylinder extend line 90 and from there back to the tank through port A.

As will be appreciated, the hydraulic control system 84 can be made from an aluminum block 410 that is machined, drilled and tapped accordingly into a manifold, such as a valve body. The specifics regarding the pressure settings of the various valve assembly components are only provided as examples and are not intended to limit the invention in any way.

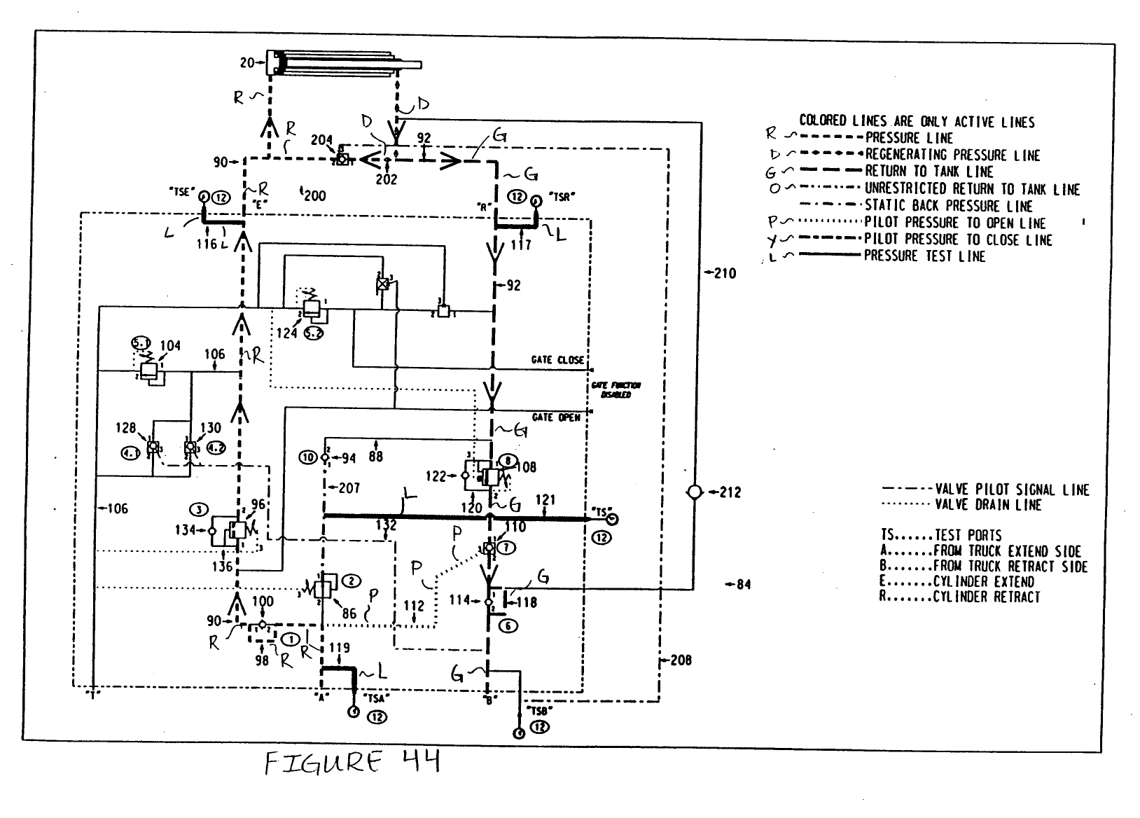

Referring to FIGS. 44-47, there is shown a modified form of the hydraulic control system 84 depicted in FIGS. 40 and 41 and of the one described in LeRoy Hagenbuch's U.S. published patent application 20030223849, published on Dec. 4, 2003 (filed on Feb. 25, 2003) and in WIPO publication WO03072392 A3. This modified hydraulic control system 84 is more similar to the one shown in FIGS. 40 and 41, several parts of regenerative hydraulic circuit 200 are located outside of the valve body 410.

As hydraulic cylinder 20 is being extended, regenerative hydraulic circuit 200 causes oil coming out of the retract side (of the hydraulic cylinder 20) to be directed into the extend side of the cylinder. Regenerative circuit 200 includes regenerative line 202 that connects the retract side of the hydraulic cylinder 20 to extend line 90 through a pressure operated check valve 204. In one form, pressure operated check valve 204 is a pressure to close check valve that close based on a pilot pressure signal from retract line 92 through pilot line 208. In simple terms, the extend line 90 (that goes to the extend side of the cylinder) is connected with the retract line 92 (that goes to the retract side of the cylinder) through a regenerative line 202 and pressure operated check valve 204. When the cylinder is extending, oil comes from the retract side of the cylinder (that would normally flow back to tank) and flows into the extend side of the cylinder through regenerative circuit 200. However, when the cylinder is retracting, a signal pressure coming from the retract input pressure line 92 (through pilot line 208) to the pressure operated check valve 204 and closes pressure operated check valve 204 to prohibit oil from flowing from the retract side of the cylinder to the extend side of the cylinder.

A supplemental retract line 210 and check valve 212 external to the main hydraulic valve manifold to increase the capacity of fluid that can flow toward the retract side of hydraulic cylinder 20 (instead of internal as depicted in FIGS. 41-42). Also, restrictive orifices 102 and 125 have been removed to increase the flow of hydraulic fluid toward the retract side of hydraulic cylinder 20. Although they are shown in the drawings, check valves 100 and 114 are not necessary because, in this case, there is no need to restrict the flow through bypass lines 98 and 118. Therefore, check valves 110 and 114 could be removed and bypass lines 98 and 118 can be removed. In this example, counterbalance valve 108 has been modified so that the predetermined value that will cause it to open is 1500 psi., instead of the 1000 psi. Pressure relief valves 104 (and 124) are modified to direct hydraulic fluid back to a hydraulic fluid reservoir or tank when the pressure in extend line 90 (or 92) exceeds approximately 2000 psi (although in reality, the pressure relief valve typically operates under a range of pressure, such as 1800-2300 psi.

When the pressure in pilot line 208 is equal to or greater than the pressure in retract line 92 (at a point below counterbalance valve 108), then pressure operated check valve 204 will normally close and fluid will no longer flow through regenerative circuit 200 (unless the pressure ratio is exceeded). In this case, pressure operated check valve 204 was selected to have a ratio of 1:1.8 so that so that that as long as the pressure in regenerative line 202 is no greater than 1.8 times the pressure in the pilot line 208, the pressure operated check valve 204 will close and block flow through regenerative circuit 200.

During extension of hydraulic cylinder 20, pressurized hydraulic fluid is first directed into the hydraulic control system 84 through port A in a manner similar to that described for the system in FIGS. 40 and 41. In this case, counterbalance valve 108 remains closed until the pressure in line 92 exceeds 1500 psi and directs the hydraulic oil from the retract side through regenerative line 202 and the open pressure operated check valve 204. When the pressure in retract line 92 exceeds 1500 psi, counterbalance valve 108 will open and allow the hydraulic oil coming out of the retract side of the cylinder to flow through retract line 92 and back to the tank. Whenever the pressure in retract line 92 falls below 1500 psi, counterbalance valve 108 will stay closed and the oil will go back to flowing through the regenerative circuit 200.

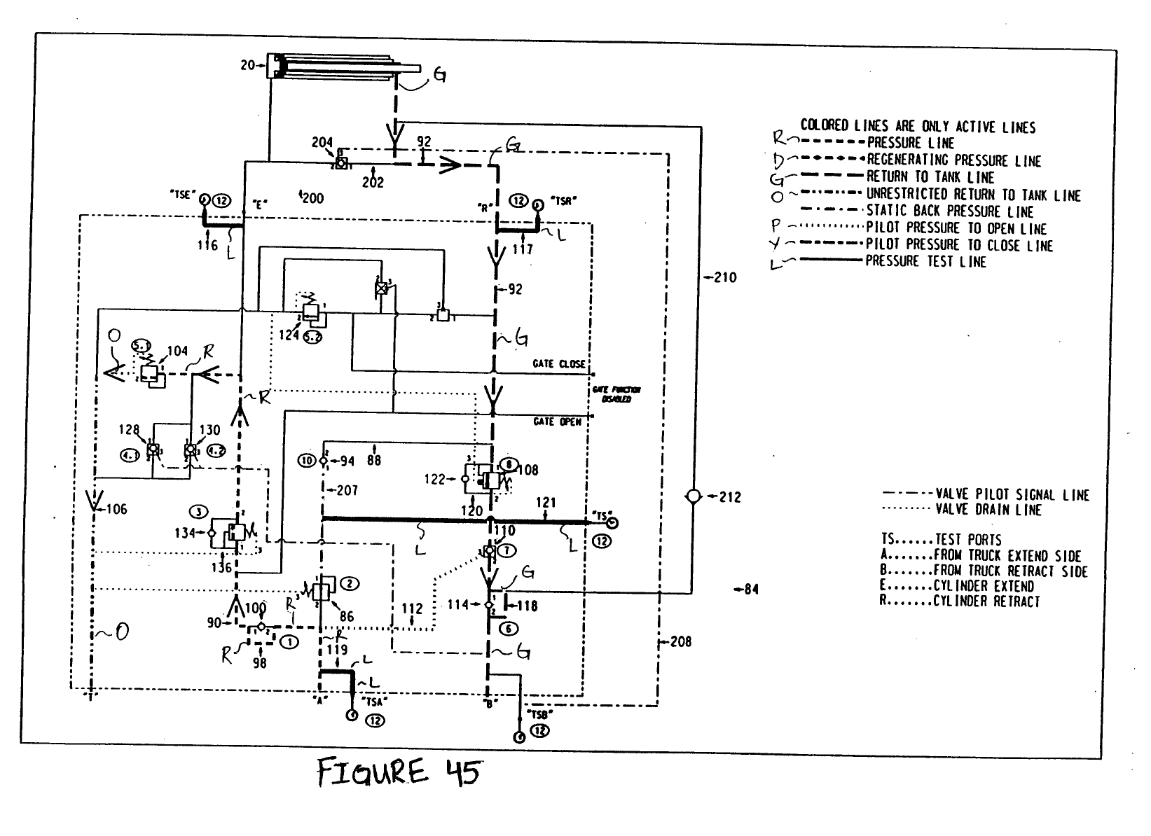

During the extension process, if the pressure on the extend side (such as in extend line 90) exceeds 2000 psi, then pressure relief valve 104 opens and fluid is directed back to the hydraulic fluid reservoir or tank as shown in FIG. 45.

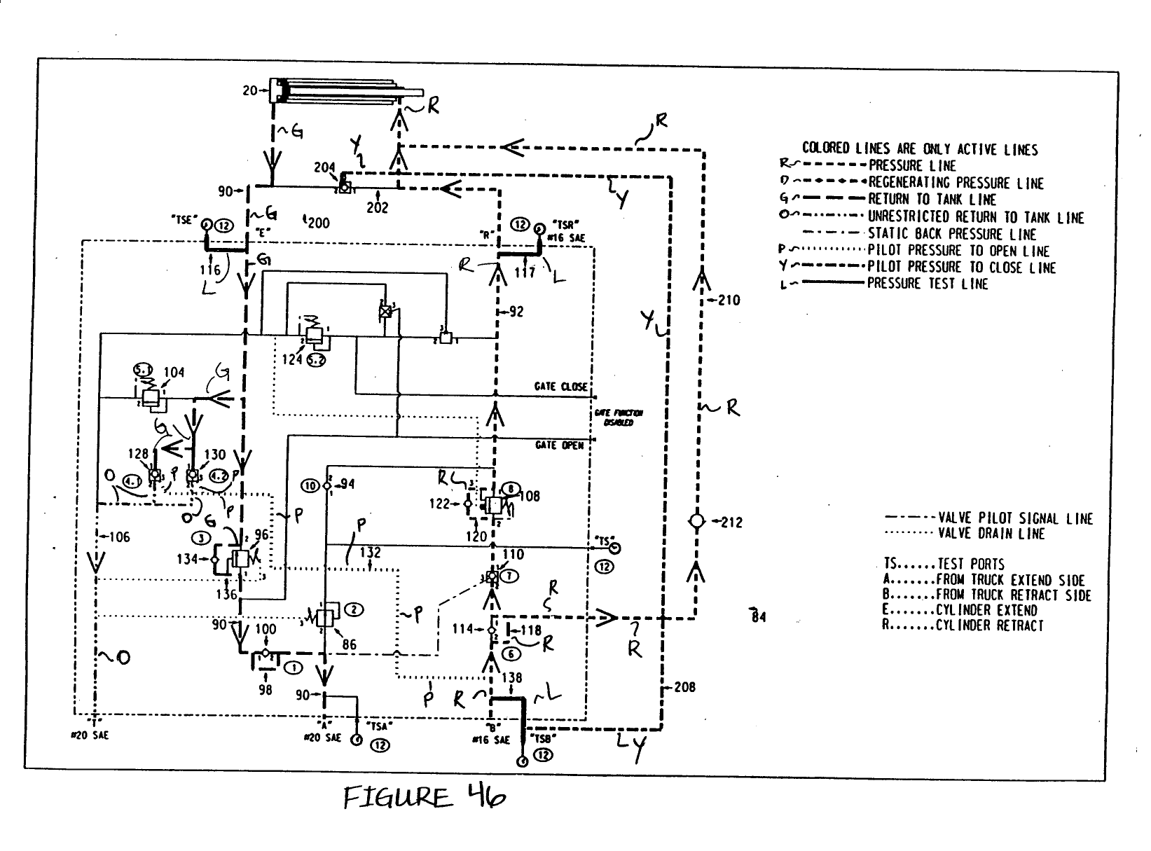

Referring now to FIG. 46, when the hydraulic cylinder 20 retracts, hydraulic fluid enters port B and is directed to retract line 92 and supplemental retract line 210. Supplemental retract line 210 is provided to provide additional capacity that is not available through retract line 92 because, in a prototype, valves 108 and 110 were not sized properly (they were not large enough to allow sufficient flow capacity) for this application. It should be noted that supplemental retract line 210 would be redundant if valves 108 and 110 were properly sized. An inline check valve 212 is located within supplemental line 210 in order to allow hydraulic oil to flow directly from port B to the retract side of cylinder 20. (Check valve 212 also prevents hydraulic fluid from flowing through supplemental line 210 during extension of cylinder 20.)

As hydraulic oil is being pumped into the retract side of the cylinder 20, the pressure in pilot line 208 is equal to or greater than the pressure in retract line 92, thereby causing pressure operated check valve 204 to close. This prevents hydraulic oil from flowing through regenerative circuit 200 and, instead, causes the hydraulic oil to flow into the retract side of the cylinder.

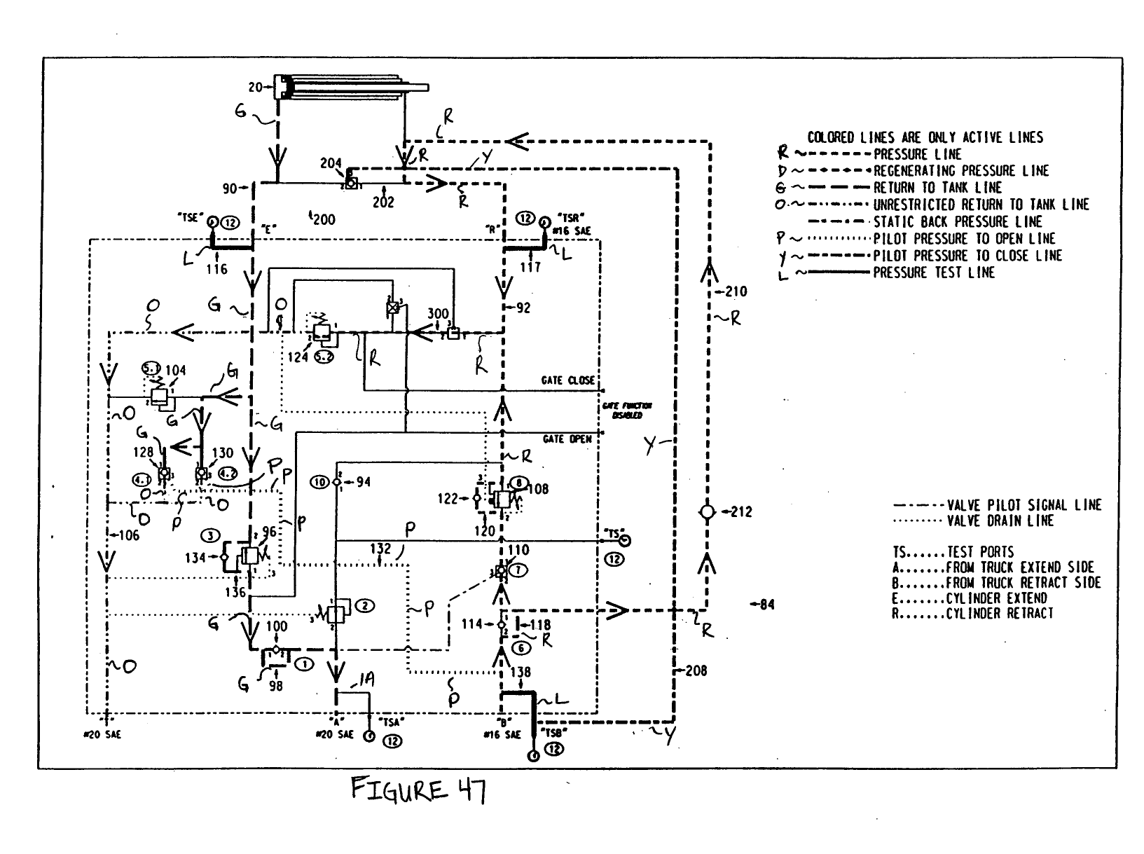

During the retraction process, if the pressure on the retraction side (such as in retract line 92) exceeds 2000 psi, then pressure relief valve 124 opens and fluid is directed back to the hydraulic fluid reservoir or tank as shown in FIG. 47.

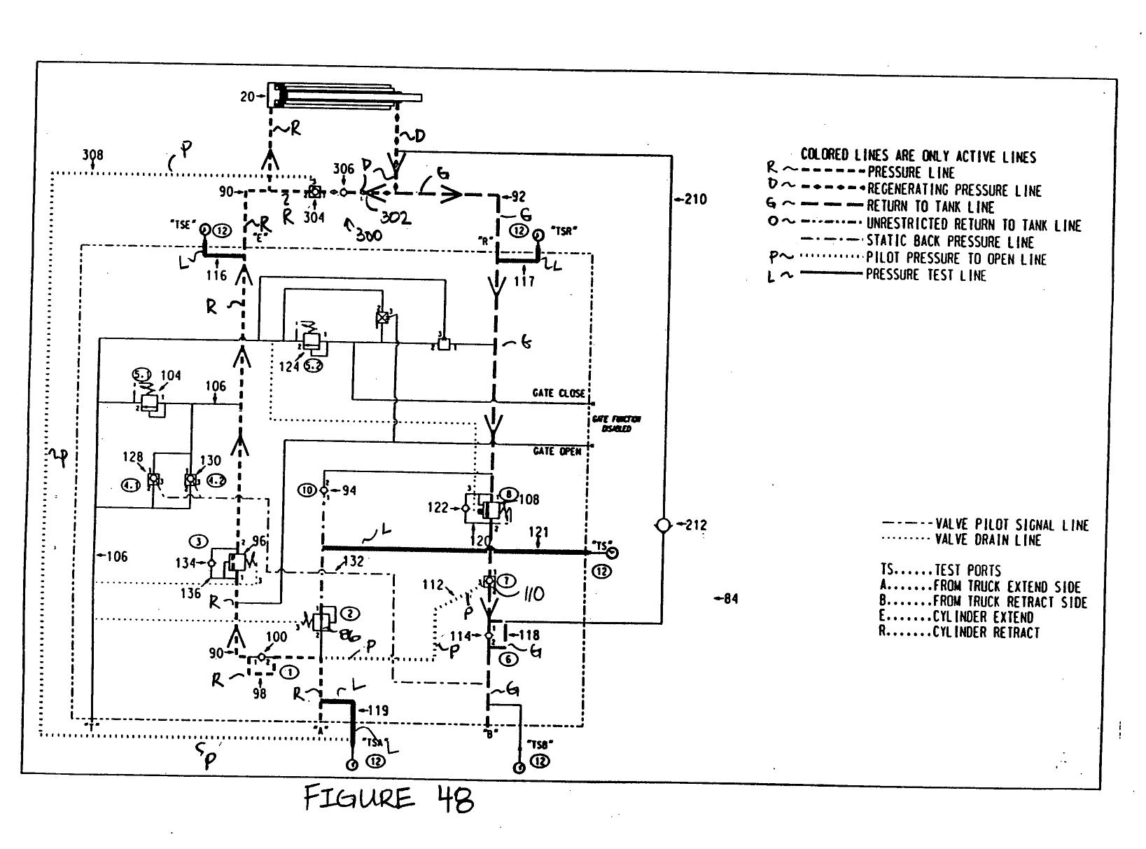

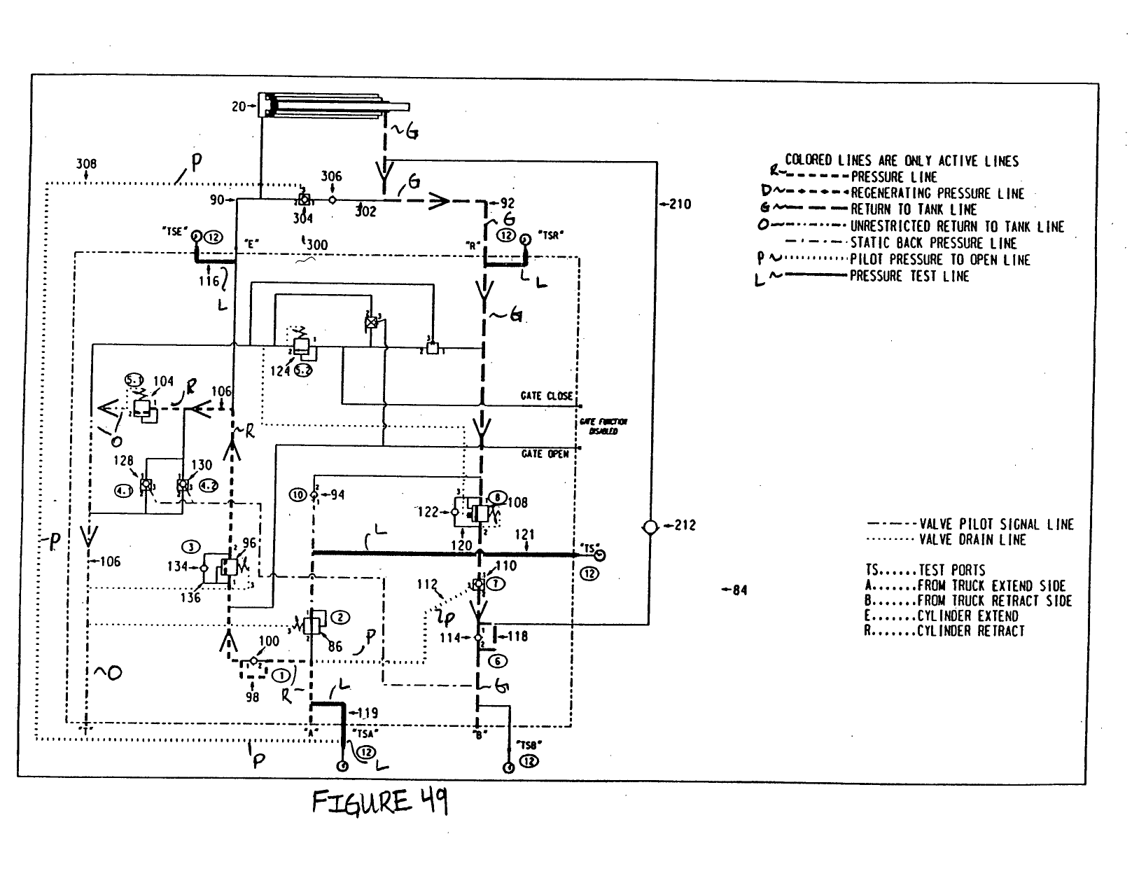

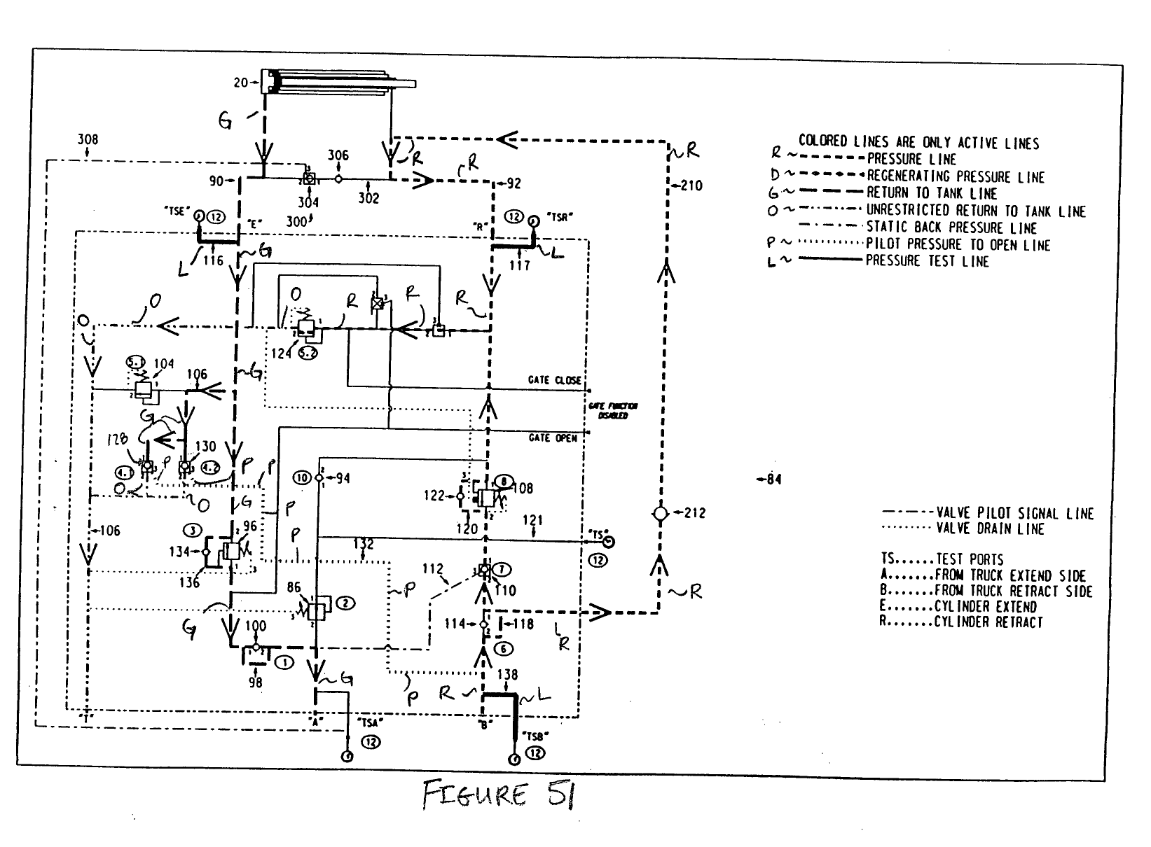

Because of the similarities with the version depicted in FIGS. 40 and 41, additional detailed discussion concerning the working of many similar features and structures has been omitted. For the same reason, the description concerning FIGS. 48-51 (below) has also been abbreviated.

It should be noted that the modification shown in FIGS. 44-47 can cause cylinder 20 to drift open unintentionally. Therefore, a device can be added to lock cylinder in place in the closed position to prevent this unintentional drift.

Referring now to FIGS. 48-51, there is shown a further modification that is designed to prevent such drift. In many respects, this modification is similar in parts and function as that shown in FIGS. 40 and 41 and 44-47. Like the version shown in FIGS. 44-47, it is contemplated that many of the parts that are shown as being external to the valve body can also be made internal to the valve body. Likewise, the other suggested modifications concerning the version depicted in FIGS. 44-47 can also be made here. It is contemplated, however, that pilot line 208 would be omitted along with valve 204.

For the most part, the embodiment in FIGS. 48-51 is quite similar to the embodiment shown in FIGS. 44-47. However, some modifications have been made to prevent the unintentional drift found in the embodiment of FIGS. 44-47. Like before, regenerative circuit (here labeled 300) includes a regenerative line 302 and a “regenerative” pressure operated check valve 304. In this case, pressure operated check valve 304 is a pressure to open check valve that opens based on a pilot pressure signal from extend line 90 through pilot line 3.08. In a somewhat similar manner as discussed concerning FIGS. 44-47, regenerative circuit 300 causes hydraulic fluid from the retract side (of hydraulic cylinder 20) to flow into the extend side (of hydraulic cylinder 20) when hydraulic cylinder 20 is undergoing extension.

In one form, extend line 90 is connected with the retract side of the cylinder 20 through a pressure to open hydraulic valve 304 and an inline check valve 306. The inline check valve 306 only allows flow in one direction in this line, i.e. from the retract side of the cylinder to the extend side of the cylinder. Therefore, when the cylinder is extending, oil exiting from the retract side of the cylinder (that would normally flow back to tank) goes instead into the extend side of the cylinder through the regenerative circuit 300. When the cylinder is being retracted the pilot to open regenerative valve 304 is closed, thereby prohibiting oil from flowing from the retract side of the cylinder 20 to the extend side of the cylinder 20.

Inline check valve 306 is installed in regenerative line 302 to prevent hydraulic fluid from flowing from the extend side (of the hydraulic cylinder 20) to the retract side (of the hydraulic cylinder 20) during the extend mode of operation. Here, the pilot or signal line pressure line (from pilot line 308) has been added to allow a pilot signal to come from extend line 92 (or the extend inlet port on the hydraulic valve manifold), during extension of hydraulic cylinder 20, to open pressure operated check valve 304. In other words, when hydraulic cylinder 20 is extending, a pilot signal goes to pilot line 308 to open pressure operated check valve 304, thereby allowing oil to flow from the retract side of the cylinder 20 to the extend side of the cylinder 20 as long as the pressure in the extend side of the cylinder is below the setting of valve 108. During the extend mode, anytime the pressure in the retract side is below 1500 p.s.i., valve 108 stays closed and oil will flow through regenerative circuit 300 from the retract side of the hydraulic cylinder to the extend side.

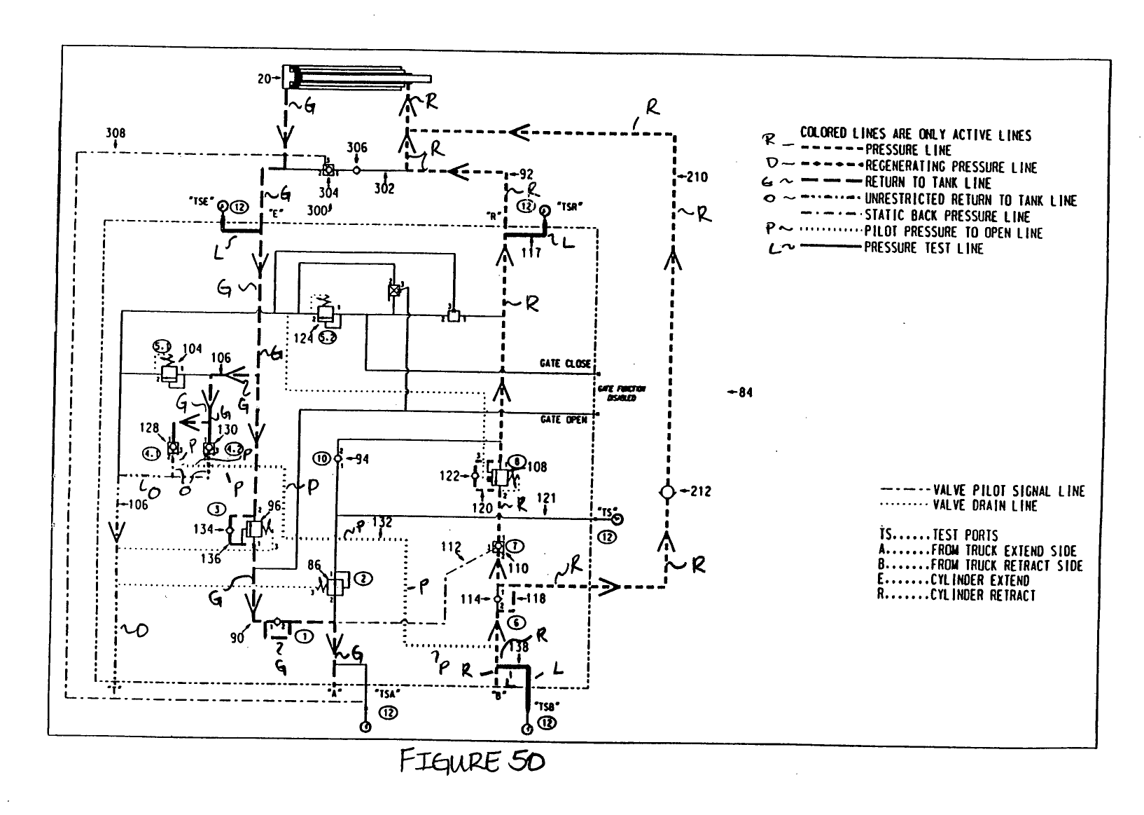

Referring to FIG. 50, as oil is forced into the retract side of the cylinder during the retraction mode, the pressure operated check valve 304 will remain closed because during retraction there is no pressure in the extend line 90 to create a signal pressure to open the pressure operated check valve 304.

In one form, pressure operated check valve 304 has a ratio of 1:1.8, so as long as the pressure in the pilot line 308 is equal or greater than the pressure in the extend line 90 pressure to open valve 304 will open. The 1:1.8 ratio means as long as the pressure in regenerative line 300 that we are attempting to open is no greater than 1.8 times the pressure in the pilot line 308, then the pressure to open valve 304 will open and allow flow between the retract and extends side of the hydraulic cylinder 20, while the inline check valve 306 will prevent oil flow from the extend side of the cylinder to the retract side of the cylinder in all cases.

All references, including publications, patent applications, and patents, cited herein are hereby incorporated by reference to the same extent as if each reference were individually and specifically indicated to be incorporated by reference and were set forth in its entirety herein.

The use of the terms “a˜˜ and “an˜˜ and “the˜˜ and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Of course, variations of those preferred embodiments will become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject mailer recited in the claims appended hereto as permitted by applicable law. Moreover, any combination of the above-described elements in all possible variations thereof is encompassed by the invention unless otherwise indicated herein or otherwise clearly contradicted by context.

1. A rear eject body for a truck comprising:
a floor,
a pair of opposing sidewalls,
an ejector supported in the rear eject body for movement between a retracted position at a forward end of the body and an extended position at the rear end of the body,
a hydraulic cylinder for moving the ejector between the retracted and extended positions, the hydraulic cylinder being configured to extend and thereby move the ejector towards the extended position when hydraulic fluid is supplied to an extend side of the hydraulic cylinder and to retract and thereby move the ejector towards the retracted position when hydraulic fluid is supplied to a retract side of the hydraulic cylinder, and
a hydraulic control system for controlling the flow of hydraulic fluid to and from the extend and retract sides of the hydraulic cylinder, the hydraulic system being configured lo allow hydraulic fluid flow out of the retract side of hydraulic cylinder through a line connecting the retract side of the hydraulic cylinder directly to the extend side of the hydraulic cylinder, during extension of the hydraulic cylinder, thereby supplying hydraulic fluid to the extend side of the hydraulic cylinder from the retract side and bypassing a hydraulic fluid tank.

2. The rear eject body according to claim 1 wherein the hydraulic control system allows at least some of the flow of hydraulic fluid out of the retract side of the hydraulic cylinder to the hydraulic fluid tank, instead of flowing through the regenerative hydraulic circuit, when the pressure in the retract side of the hydraulic cylinder exceeds a predetermined value.

3. The rear eject body according to claim 1 wherein hydraulic fluid flow from a hydraulic dump circuit provides at least some of the flow of the hydraulic fluid to and from the extend and retract sides of the hydraulic cylinder.

4. The rear eject body according to claim 3 wherein the hydraulic control system is configured to build backpressure into the retract side of the hydraulic cylinder before hydraulic fluid is allowed to flow to the extend side of the hydraulic cylinder to initiate extension of the hydraulic cylinder.

5. The rear eject body according to claim 4 wherein the hydraulic control system allows the flow of hydraulic fluid out of the retract side of the hydraulic cylinder to a hydraulic fluid tank when the backpressure in the retract side of the hydraulic cylinder reaches a predetermined value.

6. The rear eject body according to claim 4 wherein the hydraulic control system throttles the flow of hydraulic fluid to the extend side of the hydraulic cylinder.

7. The rear eject body according to claim 6 wherein the hydraulic control system allows the flow of hydraulic fluid out of the extend side of the hydraulic cylinder and back to a hydraulic fluid tank when the pressure in the extend side of the hydraulic cylinder exceeds a predetermined value.

8. The rear eject body according to claim 1 further comprising:
a tailgate extending between the opposing sidewalls at a rear end of the rear eject body, the tailgate being pivotally supported for movement between an open position and a closed position,
a tailgate hydraulic cylinder for moving the tailgate between the open and close positions, and
a common hydraulic control system for controlling the flow of hydraulic fluid to and from both the eject hydraulic cylinder and the tailgate hydraulic cylinder.

9. The hydraulic cylinder according to claim 1 further comprising a mechanism that prevents the hydraulic cylinder from drifting open unintentionally.

10. The hydraulic cylinder according to claim 9 wherein the hydraulic control system prevents the hydraulic cylinder from drifting open unintentionally.

11. A rear eject body comprising:
a floor,
a pair of opposing sidewalls,
an ejector supported in the rear eject body for movement between a retracted position at a forward end of the body and an extended position at the rear end of the body,
a hydraulic cylinder for moving the ejector between the retracted and extended positions, the hydraulic cylinder being configured to extend and thereby move the ejector towards the extended position when hydraulic fluid is supplied to an extend side of the hydraulic cylinder and to retract and thereby move the ejector towards the retracted position when hydraulic fluid is supplied to a retract side of the hydraulic cylinder,
a hydraulic control system for controlling the flow of hydraulic fluid to the extend and retract sides of the hydraulic cylinder, the hydraulic system being configured to build backpressure into the retract side of the hydraulic cylinder before hydraulic fluid is allowed to flow to the extend side of the hydraulic cylinder to initiate extension of the hydraulic cylinder, and
a regenerative hydraulic circuit in fluid connection between the extend side and the retract side, the regenerative circuit allowing hydraulic fluid flow from the retract side to the extend side by bypassing a hydraulic fluid tank during extension of the hydraulic cylinder.

12. The rear eject body according to claim 11 wherein the hydraulic control system allows at least some of the flow of hydraulic fluid out of the retract side of the hydraulic cylinder to the hydraulic fluid tank, instead of flowing through the regenerative hydraulic circuit, when the pressure in the retract side of the hydraulic cylinder exceeds a predetermined value.

13. The rear eject body according to claim 11 wherein hydraulic fluid flow from a hydraulic dump circuit provides at least some of the flow of the hydraulic fluid to and from the extend and retract sides of the hydraulic cylinder.

14. The rear eject body according to claim 11 wherein the hydraulic control system is configured to build backpressure into the retract side of the hydraulic cylinder before hydraulic fluid is allowed to flow to the extend side of the hydraulic cylinder to initiate extension of the hydraulic cylinder.

15. The rear eject body according to claim 11 wherein the hydraulic control system throttles the flow of hydraulic fluid to the extend side of the hydraulic cylinder.

16. The rear eject body according to claim 11 further comprising:
a tailgate extending between the opposing sidewalls at a rear end of the rear eject body, the tailgate being pivotally supported for movement between an open position and a closed position,
a tailgate hydraulic cylinder for moving the tailgate between the open and close positions, and
a common hydraulic control system for controlling the flow of hydraulic fluid to and from both the eject hydraulic cylinder and the tailgate hydraulic cylinder.
